(19) United States
(12) Patent Application Publication
(10) Pub. No.: US 2026/0337881 A1
(43) Pub. Date: Oct. 29, 2026

(54) Apparatus and method of producing 3D biodegradable fiber matrix

(71) Applicant: FibriTech sp. z o.o., WARSZAWA (PL)

(72) Inventors: Rafal Brzyski, Warsaw (PL); Arkadiusz Smalski, Warsaw (PL); Artem Kulachenko, Täby (SE); Tomasz Ciamulski, Warsaw (PL)

(21) Appl. No.: 19/559,637

(22) Filed: Mar. 6, 2026

(30) Foreign Application Priority Data
Apr. 25, 2025 (EP) 25172708.7

(51) Int. Cl. D21G 9/00; D21F 5/16

(52) U.S. Cl. CPC D21G 9/0036; D21F 5/167

(57) ABSTRACT

The present invention relates to an apparatus for producing a three-dimensional biodegradable fiber network product, comprising: a chamber having an internal volume, the chamber being configured to receive natural fiber-based slurry; a heating unit configured to heat the slurry received in the chamber, comprising a heating system configured to transmit electromagnetic, EM, energy to the slurry, the heating system comprising at least two heating modes with differing heating characteristics, respectively; and a control unit configured to control the heating of the natural fiber based slurry using the heating unit to remove fluid in the slurry, so as to form the three-dimensional biodegradable natural fiber matrix, wherein the control unit is configured to monitor a heating mode condition for transitioning between the at least two heating modes in accordance with the heating mode condition.

### TECHNICAL FIELD

The present invention relates to an apparatus and a method for the preparation of a biodegradable three-dimensional fiber network product from defibrated natural organic fibers using electromagnetic (EM) energy.

### BACKGROUND

Natural organic fibers of plants or animal origin have been widely used for many years in many industries, such as paper and wood industry, due to advantageous mechanical properties including good tensile strength, low weight and specific stiffness, but also due to its renewable character and ability to be broken down by bacteria making them environment friendly.

In the paper industry, cellulose fibers used as raw material are wetted, converted into a pulp, pressed, and dried giving sheets of paper having a substantially flat shape, wherein the fibers are oriented substantially in the sheet-plane direction, which results in a product having a good tensile strength in said sheet-plane direction.

Compression into thin sheets of paper allows for effective removal of water from the material, whereas production of thicker sheets is limited and requires more energy to dry the final product.

There is a need to provide methods of manufacturing of biodegradable three-dimensional fibrous web structures of arbitrary shapes and easily controllable properties, such as density and stiffness. Forming of such materials using defibrated cellulose fibers and other biodegradable components still presents a challenge.

It is well known in the industry of fiber-based products, that drying requires spending large amounts of energy to evacuate water or other solvents used in the processing of fiber-based products. On the other hand, transportation and transfer of fibrous suspensions is more convenient using suspensions having high water content. Decreasing water content in said fibrous suspensions may lead to clogging of the equipment or undesired properties of the final product. For these reasons, fibrous suspensions of high water content are often used and said water is preferably removed by filtration, as removal of the water by evaporation is very energy-consuming. Apart from water, volatile organic compounds (VOCs) are used as a liquid carrier or solvent that allows for lowering of the temperature needed for their evaporation. However, volatile organic compounds are not environment friendly and attempts are made to develop more green processes.

Theoretically, as much as 0.6 kWh per each kg of water is needed for its evaporation. This does not include energy needed to heat water to a boiling point. In practice, more than 1 kWh is needed per each kg of water for its removal in industrial processes.

EP4036307A1 introduces a three-dimensional biodegradable fiber network product for various applications. These three-dimensional biodegradable fiber network products are obtained by applying electromagnetic energy to a foamed aqueous solution of natural organic fibers inside a porous chamber.

One of the issues associated with producing fiber-based products at an industrial scale is a high cost, as the drying out of moisture from a fiber-based slurry requires a long processing time and consumes a lot of energy. These disadvantages in turn affect the promotion and popularity of using environment-friendly biodegradable fiber materials in industrial scale.

Therefore, it is the aim of the present invention to provide an improved apparatus and a method of producing a three-dimensional biodegradable fiber material.

### SUMMARY

In a first aspect, an apparatus for producing a three-dimensional biodegradable fiber network product is suggested, comprising: a chamber having an internal volume, the chamber being configured to receive natural fiber-based slurry; a heating unit configured to heat the slurry received in the chamber, comprising a heating system configured to transmit electromagnetic, EM, energy to the slurry, the heating system comprising at least two heating modes with differing heating characteristics, respectively; and a control unit configured to control the heating of the natural fiber based slurry using the heating unit to remove fluid in the slurry, so as to form the three-dimensional biodegradable natural fiber matrix, wherein the control unit is configured to monitor a heating mode condition for transitioning between the at least two heating modes in accordance with the heating mode condition.

The claim feature defines a heating system that is configured to apply electromagnetic energy to a slurry comprising natural fibers and fluid, wherein the system includes at least two heating modes with different heating characteristics. Additionally, a control unit is provided that is capable of monitoring a heating mode condition and transitioning between the different heating modes based on the monitored condition.

This means that the heating system is not limited to a single energy modality but integrates two or more distinct electromagnetic heating modes with differing characteristics, which will be described later. For example and without limitation, characteristics may include different heating technologies, such as direct current resistive heating, radio frequency dielectric heating, and microwave heating, each offering different penetration depths, energy coupling behaviors, and drying effects.

The at least two heating modes may be implemented in physically separate sub-chambers with conveyance between them, or may be implemented within a single chamber by sequentially applying different electromagnetic regimes over time.

The control unit actively determines the appropriate moment to shift from one heating modality to the next.

In the technical context of forming three-dimensional biodegradable fiber matrix products, such as foamed packaging or structural components from aqueous slurries, controlled and efficient removal of moisture is essential to achieving the required structural stability and material properties. Different stages of drying impose different thermal and fluid dynamic requirements. For example, initial stages may benefit from low-intensity, volumetric heating that gently removes bulk water from the internal mass, whereas later stages require high-intensity, surface-targeted heating to solidify and lock the outer shell without compromising internal integrity. The use of multiple electromagnetic heating modes allows the process to be tailored to these evolving material conditions.

Various electromagnetic heating approaches have been previously explored to accelerate the removal of moisture from biodegradable or fiber-based foam materials. Prior systems often employed single-mode microwave drying, which offers rapid volumetric heating but exhibits inherent limitations, particularly when used alone in high-moisture, thick foam applications. Notably, single-frequency microwave drying frequently leads to local overheating, pronounced internal moisture gradients, and structural instabilities such as sagging, warping, or the formation of dense fiber clumps. These effects are exacerbated in thicker foam bodies due to the short penetration depth of microwave energy at industrial frequencies such as 2.45 GHZ and the steep moisture gradient that arises once surface water evaporates faster than internal moisture can diffuse.

Radio frequency heating has also been applied to natural fiber materials. Owing to its longer wavelength, RF energy penetrates more deeply and produces a more uniform heating field, especially in lower-moisture content zones. However, RF heating alone has proven insufficient for the rapid early-stage drying of aqueous fiber slurries, as its power density is typically lower, and the field strength may be inadequate to drive off bulk water in high-moisture conditions.

Attempts to use either microwave or RF heating in isolation have revealed several drawbacks, including non-uniform drying, internal fiber lumping, excessive energy consumption, and deformation of the final product due to uncontrolled local vaporization or uneven shrinkage.

The technical challenges inherent to dielectric drying of foamed slurries arise from the dynamic change in moisture content during processing. The dielectric properties of the material evolve significantly as the water content decreases, thereby altering the interaction with the applied electromagnetic fields. For instance, the penetration depth of microwave energy diminishes and field matching conditions shift as the dielectric constant and loss factor of the material decline during drying. These changes demand careful control of field strength, exposure duration, and mode transitions to avoid process failure or poor product quality.

By employing heating modes with differing characteristics, the system can adapt the heating profile to the dynamic response of the material. This enables a more uniform and efficient drying process compared to conventional systems that rely on a single heating source, such as hot air convection or infrared radiation, which are typically limited in penetration and difficult to control precisely.

In a preferred embodiment, the invention relates to a three-dimensional biodegradable fiber network product, which is formed by structuring natural organic fibers into a spatial matrix using electromagnetic heating methods. The product comprises a self-supporting, porous structure of interlaced or interlocked fibers, which are bonded by physical entanglement and optionally by thermally or chemically activated binding agents. The final product is biodegradable, lightweight, and dimensionally stable, and is formed in a mold—which may be realized at least in part by the chamber—into a predetermined three-dimensional geometry.

The product is preferably employed in a range of sustainable applications, including but not limited to packaging solutions as a biodegradable alternative to expanded polystyrene or molded pulp, acoustic insulation panels for automotive or architectural uses, disposable thermal containers for food, catering, or delivery systems, structural filler components in furniture or lightweight construction elements, compostable plant trays, nursery pots, or agricultural substrates, and bio-based consumer products or single-use items. The product is particularly suitable in contexts where end-of-life compostability and sustainable production are of strategic relevance.

The product is composed primarily of natural organic fibers, preferably selected from the group consisting of cellulose fibers such as wood pulp, cotton, flax, or hemp, ligno-cellulosic fibers including jute, kenaf, bamboo, or straw, agro-industrial residues such as bagasse, coconut coir, or cereal husk fibers, and algae-derived fibers or fibers produced from fungi such as mycelium strands. In a preferred embodiment, the fibers are mechanically defibrated and dispersed in an aqueous medium to form a foam and are subsequently formed into a network during the drying phase. The fibers may have aspect ratios between 10:1 and 1000:1, preferably between 50:1 and 500:1, and may include microfibers with lengths below 100 micrometers and long fibers with lengths greater than 2 millimeters, depending on the mechanical strength and porosity desired in the final product.

In a particularly preferred embodiment, the fiber length ranges between 0.2 millimeters and 10 millimeters and the diameter between 5 micrometers and 100 micrometers, with an average length of 2 to 4 millimeters. The fiber distribution is controlled to achieve a balance between mechanical integrity and permeability during molding and drying. The bulk density of the finished product is preferably between 10 and 250 kilograms per cubic meter, more preferably between 30 and 120 kilograms per cubic meter, depending on the application. For packaging and thermal applications, lower densities are favored, while acoustic and structural components may use higher densities.

In preferred embodiments, the fiber foam composition may include one or more biodegradable additives. These may include foam stabilizers such as agar, xanthan gum, or chitosan, binding agents including starch in native or modified form, dextrin, pectin, or protein-based materials such as soy or casein, crosslinking agents such as citric acid or calcium salts optionally activated during thermal exposure, hydrophobic coatings or additives including natural waxes or fatty acid esters to improve water resistance, blowing agents such as sodium bicarbonate or other gas-evolving compounds to enhance expansion, and biodegradable surfactants such as coco glucoside to promote uniform fiber dispersion. Each of the above components is preferably included at a weight fraction of 0.1 to 10 percent based on the total solids in the foam suspension and is selected based on the desired mechanical properties, drying behavior, and environmental profile.

The slurry is optionally disposed within a mold that is preferably composed of a material with low EM losses and high temperature resistance, such as PTFE, PEEK, or advanced ceramics. In other embodiments, the mold can comprise or consist of fabric. In one embodiment, the slurry itself is supported by or embedded within a dielectric tray that maintains consistent distance from the electrodes and provides mechanical stability. The optional mold is perforated with pores having diameters between 0.5 mm and 2 mm and a total surface porosity of 1% to 15%, to allow water vapor generated during heating in any electromagnetic, EM, heating mode to escape. The technical effect of the porous mold is the pressure-controlled drying of the product, which preserves foam structure and avoids blistering or shrinkage.

The resulting product exhibits a micro- to mesoporous fiber matrix with open-cell porosity typically exceeding 50 percent and in preferred cases greater than 70 percent depending on the drying process. The porosity is tailored by adjusting the mold geometry, heating gradients, and evaporation rate, allowing the production of materials with either isotropic or anisotropic mechanical behavior. The technical effect of this structure is to create load-diffusing, thermally insulating, and shock-absorbing properties while maintaining low weight and full biodegradability.

In the present invention, biodegradable means that the material, such as the natural fiber, can be broken down by the action of microorganism, such as bacteria, fungi, or algae to a natural state that will not harm the environment. Nature fiber based slurry in the present invention refers to the suspension of natural fibers in water or nature fiber pulp. Preferably, the nature fiber is cellulose fiber. Cellulose is a carbohydrate, or polysaccharide, consisting of a linear chain of several hundred to many thousands of β (1→4) linked D-glucose units. It is an essential structural component of the primary cell wall of green plants, many forms of algae, and the oomycetes. In the present invention, the source of the cellulose used is not limited. It can stem from wood, cotton, hemp, or even recycled paper. They are biodegradable and thus offer an environment-friendly solution to oil spill cleaning up.

Fiber matrix in the present invention refers to an interconnected, network-like structure. Such matrix structure may look similar to a bird nest. The concrete shape of the structure is not essential here. Depending on the shape of the chamber, or by adopting a post process of cutting, the resulted product can be any shape, such as block, tube, matt, or the like.

Various methods for the thermal treatment and drying of water-containing materials are known in the art. Among these, dielectric heating techniques, particularly those involving radio frequency (RF) and microwave (MW) electromagnetic fields, have been increasingly adopted due to their ability to provide rapid, volumetric, and energy-efficient heating, especially in moisture-laden porous structures.

The chamber is a space in which the natural fiber based slurry is received. The slurry may be provided within the chamber in a mold, such that the mold is positioned within the chamber. In other embodiments, at least part of the chamber or the entire chamber may itself form the mold, i.e., the slurry can be directly placed within the chamber then acting to present for instance boundaries to the product.

In the present invention, the shape of the chamber is not limited. The chamber may also function as a mold, namely the shape of the chamber determines the shape of the final product. According to specific application needs, the chamber can have a pad, sleeve, or cube shape. It is also imaginable that the chamber can have a shape of a spoon, a bowl, a cup, or the like, for producing biodegradable disposable utensils for food industry.

In the present invention, the control unit is configured to control the heating unit. Depending on specific requirements of the application, the control unit can be a microcontroller (μC), a personal computer (PC), a tablet, or an industrial computer, which has a high processing capabilities for sophisticated tasks.

In a preferred embodiment, the differing heating characteristics are selected from the group comprising: heating type, frequency, power density, duty cycle, field distribution, or any combinations thereof.

Heating type refers to the physical mechanism by which electromagnetic energy is converted into heat within the material. In the present context, heating type preferably includes conductive heating (direct current heating), where heat is generated by Joule heating as an electric current flows through the electrically resistive aqueous slurry; radio frequency heating, where dielectric loss is induced by dipole reorientation in an alternating electric field; and microwave heating, where high-frequency fields cause rapid dipolar agitation of water molecules. Each heating type has a distinct penetration depth, energy coupling behavior, and heat distribution. For example, conductive heating is suitable for low-temperature preheating due to its uniform but mild heating action, RF heating is ideal for volumetric drying of thick sections, and microwave heating is effective for rapid surface or near-surface drying.

Frequency refers to the rate at which the electromagnetic field oscillates, typically measured in hertz. Frequency determines how deeply the field penetrates the material and how efficiently energy is absorbed by polar molecules. Lower frequencies, such as 13.56 MHz or 27.12 MHz in RF systems, penetrate more deeply and heat more uniformly through thick materials. Higher frequencies, such as 915 MHz or 2.45 GHz in microwave systems, penetrate less deeply but heat more intensively in thin or moderately thick sections. Frequency selection is therefore crucial for matching the heating mode to the product geometry and water distribution.

Power density refers to the amount of energy delivered per unit volume or per unit mass of the material, usually expressed in kilowatts per kilogram or watts per cubic centimeter. Higher power densities can accelerate the drying process but risk overheating or degrading the fiber matrix if not carefully controlled. For example, in the early stages of drying, a power density of 1 to 2 kilowatts per kilogram may be used during RF heating to efficiently remove bulk moisture, while final microwave drying may apply 3 to 6 kilowatts per kilogram in short bursts to lock in the product shape.

Duty cycle refers to the temporal pattern in which energy is applied, typically expressed as a percentage of the time the system is active within a given cycle. A 50 percent duty cycle means the energy is applied half the time and off the other half. Pulsed heating with adjustable duty cycles is often used to allow thermal equalization between bursts of energy, reducing the risk of localized overheating and allowing moisture to redistribute. For example, pulsed microwave heating at a 20 percent duty cycle may be employed to gently dry surface moisture without overheating the outer shell of the product.

Field distribution describes how the electromagnetic field is spatially arranged and distributed within the heating chamber. Field uniformity is critical to ensure even drying across the entire volume of the molded product. In RF systems, field distribution can be modified by adjusting electrode geometry or spacing. In microwave systems, field distribution is influenced by waveguide placement, cavity shape, mode stirrers, and rotating platforms. For example, a rotating turntable in the microwave chamber helps expose all sides of the mold to similar field intensities, improving uniformity and reducing hot spot formation.

Together, these parameters define the heating characteristics of the system and enable a high degree of control over the drying process, allowing it to be precisely adapted to the evolving conditions of the fiber slurry as it transitions from a wet foam to a stable, shaped fiber network structure.

In the technical context of processing natural fiber-based slurries into three-dimensional biodegradable fiber network products, the ability to modify these characteristics allows for precise control of how and where energy is deposited into the material during drying.

Conventional drying systems, including hot air ovens, infrared lamps, or static microwave systems, typically operate with fixed heating parameters that do not accommodate the evolving thermal and moisture profile of the fiber slurry as it dries. As a result, such systems often suffer from uneven drying, overheating at the surface, underdrying in the core, and excessive energy consumption. In contrast, the claimed feature allows the system to adjust not only the type of heating but also the specific characteristics of that heating to match the material's needs at each stage of processing. This enables staged drying profiles with improved uniformity, faster throughput, reduced energy use, and better structural outcomes.

Furthermore, the ability to combine characteristics—for instance, by using conductive heating at a lower frequency and moderate power density for initial water removal, followed by RF heating or microwave heating at high power with spatial field modulation for final drying-enables the system to be finely tuned to a wide range of product types, thicknesses, and compositions. This provides a level of flexibility and process customization that is not feasible in monomodal or static heating systems and is particularly valuable for industrial-scale production where consistent quality and process efficiency are critical.

In a preferred embodiment, the differing heating characteristics comprise frequencies differing by at least a factor of two, preferably by at least a factor of ten.

In a preferred embodiment, differing heating characteristics differ by at least 10% in at least one heating characteristic, the 10% being determined based on the higher of the two values. In this embodiment, heating characteristics are considered equal to each other if they differ by less than 10% and different from each other when the difference exceeds 10%.

In a preferred embodiment, the apparatus further comprises at least one sensor, configured to monitor one or more material-state parameters of the slurry, wherein the control unit is configured to transition between two of the at least two heating modes when a parameter monitored by the at least one sensor reaches a predetermined threshold or profile.

The integration of a condition-monitoring control unit permits a dynamic transition between heating modes based on actual, i.e. sensed, material behavior, such as temperature thresholds, moisture levels, dielectric properties, or conductivity changes. This ensures that energy input is optimized throughout the drying cycle, reduces the risk of material degradation, and improves product consistency. Furthermore, the approach allows for significant energy savings and faster cycle times by applying only the necessary energy at each phase, and by avoiding overheating or underdrying that often occur in fixed-mode systems.

Overall, a technically superior, sensor-driven, multi-stage thermal treatment strategy that aligns closely with the physical and chemical behavior of natural fiber-based slurries during drying and shaping is realized, and a flexible platform for scaling up sustainable materials processing with high reproducibility and minimal waste is provided.

The term threshold refers to a specific, pre-defined value of a monitored material-state parameter at which a control action is triggered. The threshold acts as a fixed limit or condition that, once reached or exceeded by the measured value, causes the control unit to initiate a transition from one heating mode to another. For example, a threshold may be a set temperature value such as 45 degrees

Celsius, beyond which the control system switches from direct current heating to, for instance microwave heating. Similarly, a threshold may refer to a minimum residual moisture level in the fiber slurry, such as 25 percent by weight, at which point radio frequency heating is activated to complete the drying phase. The technical function of a threshold is to ensure that heating modes are applied only when the material is in a suitable condition to receive that mode's energy efficiently and without risk of degradation.

The term profile refers to a time-dependent or condition-dependent trajectory of a monitored parameter rather than a single fixed value. A profile may describe a slope, rate of change, or trend over time or across a process phase. For example, a temperature profile may describe the increase in temperature over time and define a condition such as “transition to the next heating mode when temperature rises by more than 10 degrees within 2 minutes.” A moisture profile may indicate that the control unit transitions when the moisture content decreases below a dynamic function defined by material geometry and ambient humidity. Profiles may also be multi-parametric, for instance requiring that both temperature and moisture content simultaneously reach specific rates of change or levels before a transition occurs. The use of profiles enables the control system to respond in a more nuanced and adaptive manner to the actual behavior of the material, particularly when the drying or transformation process is non-linear or affected by complex interactions within the fiber network.

Both thresholds and profiles allow the system to make informed, material-dependent decisions about how and when to apply different heating modes.

In a preferred embodiment, the sensor is configured to monitor a parameter selected from the group comprising weight, moisture content, temperature, and dielectric permittivity, electrical conductivity; steam pressure; vapor flow; and cumulative energy input history.

The control unit preferably receives input from a suite of one or more embedded sensors positioned in or adjacent to the mold and heating chamber. These sensors provide one or more or all of the following measurable control parameters:

Weight (m), measured by weight sensor arranged, for instance, below the slurry.
Temperature (T), measured by fiber-optic or infrared thermosensors, used to guide thermal ramping and prevent overheating.
Moisture content (M), derived from capacitive, dielectric loss, or NIR moisture sensors, used to monitor drying progress.
Electrical conductivity (σ), measured via voltage-current relationships, allowing for resistive power modulation and detection of phase transitions (e.g. fiber gelation).
Dielectric permittivity (ε′, ε″), captured by RF/MW resonant frequency shifts, used to tune impedance matching networks and predict absorption dynamics.
Steam pressure or vapor flow, measured via flow sensors or pressure probes near exhaust ports, enabling controlled venting and energy dose adjustment.
Cumulative energy input history, tracked via integrated energy metering, providing a reference for energy budgeting and process repeatability.

In a preferred embodiment, the transitioning between the at least two electromagnetic energy modes is based on at least one of:
(a) a monitored parameter; and
(b) a predetermined time duration.

Each mode is best suited to a particular phase in the drying process, depending on the moisture content, thermal conductivity, and dielectric properties of the material. Transitioning too early or too late between modes can result in uneven drying, energy waste, or structural distortion of the product.

A monitored parameter refers to a real-time value detected by one or more sensors, such as temperature, moisture content, electrical conductivity, dielectric loss, or vapor pressure as discussed above. These parameters provide direct insight into the current state of the material being processed. When a monitored parameter reaches a defined threshold, it signals that the material has reached a suitable condition for the next heating phase. For example, a temperature sensor may detect that the internal temperature has reached 60 degrees Celsius, indicating the end of safe resistive heating and the need to switch to, for instance, MW heating. Similarly, a drop in moisture content below 30 percent may trigger the transition from MW to RF heating.

The time-based approach, on the other hand, relies on elapsed process time rather than real-time material feedback. Each heating mode operates for a set duration determined during process development or stored in a product-specific recipe. This approach is simpler to implement and is useful when material parameters are consistent and predictable. Time-based control ensures reliable repeatability in high-volume production settings, where sensor integration may be costly or unnecessary.

The technical advantage of combining these two transition strategies is the ability to tailor the heating process to a wide range of materials and operational constraints. The sensor-based method enables intelligent, self-adjusting transitions based on actual material response, improving energy efficiency and product quality. The time-based method provides a fallback or primary strategy in cases where sensor reliability is limited or where the drying behavior is highly consistent.

Compared to the prior art, which often uses fixed heating schedules or single-mode heating, the present feature offers greater adaptability, robustness, and control. It reduces the likelihood of overheating or underdrying, compensates for environmental variability, and supports real-time process optimization. Furthermore, it allows the same system to accommodate different product types without mechanical adjustment, reducing downtime and increasing throughput in industrial settings.

In a preferred embodiment, the internal volume of the chamber is at least 30 L, preferably at least 40 L and more preferably at least 50 L.

In the context of electromagnetic drying and forming of biodegradable fiber-based foams, the internal chamber volume determines the maximum processable batch size and directly affects the throughput, geometry accommodation, and scalability of the system. A chamber volume of 30 liters or more provides sufficient capacity to house molds of industrially relevant dimensions, such as trays, packaging components, or panels, and to process multiple parts in parallel.

Microwave ovens with internal volumes in the range of 30 to 50 liters or more are considered industrial-scale units, suitable for manufacturing environments rather than domestic or benchtop use. Such volumes enable the integration of robust waveguide systems, mode stirrers, turntables, and sensor arrays while still ensuring sufficient spacing around the mold to support even field distribution. Larger volumes also permit more flexible positioning of molds within the cavity and improve airflow and vapor evacuation, which are critical for maintaining uniform drying and structural integrity of the fiber product.

Compared to smaller microwave cavities, large-volume systems are better suited for the application of high microwave power levels, typically in the range of 1 to 10 kilowatts, without causing localized overheating or excessive energy reflection. The larger chamber provides more space for electromagnetic wave dissipation and supports higher energy input without compromising safety or uniformity. It also facilitates the integration of multi-mode systems, where RF and conductive heating modules may share the same chamber space without interference.

The technical advantage of defining a chamber volume of at least 30 liters is that it clearly positions the apparatus within the scope of industrial applications, enabling the processing of realistic production-scale molds and supporting continuous or batch production in commercial settings. This contrasts with prior art systems that are limited in capacity, unsuitable for large-format parts, or incapable of integrating multi-stage electromagnetic heating in a single unit. The disclosed volume parameters thus ensure both practical utility and industrial relevance of the apparatus.

In a preferred embodiment, the chamber is composed of a plurality of sub-chambers, each implementing one of the at least two heating modes.

This structural configuration allows for spatial separation of the distinct electromagnetic heating processes, such as conductive heating, radio frequency heating, and microwave heating. Each sub-chamber is physically dedicated to a particular heating mode and may be optimized accordingly in terms of field geometry, shielding, ventilation, and sensor integration. This design eliminates the need for field isolation within a single cavity and permits each energy mode to operate under its ideal conditions without risk of electromagnetic interference or mismatched energy delivery profiles.

In a preferred embodiment, the apparatus further comprises a transport arrangement, configured to transfer the slurry between the pluralities of sub-chambers in accordance with a control by the control unit.

The transport arrangement may include a conveyor system, a robotic arm, or a shuttle tray mechanism that moves the mold or carrier holding the fiber slurry from one heating zone to the next. The motion of the transport system is synchronized with the heating logic and sensor feedback, enabling fully automated processing where transitions between heating stages occur only when the material reaches the appropriate state. The transport mechanism ensures physical isolation of energy zones while maintaining continuity of the process flow. The technical advantage is that the system can achieve sequential heating in a scalable and modular format, suitable for high-throughput or batch production environments.

In a preferred embodiment, the heating system comprises a plurality of heating modules, each heating module associated with one of the heating modes and, preferably, with one of the plurality of sub-chambers. Each heating module may include a dedicated power source, field delivery mechanism (such as electrodes or waveguides), and local sensor system. By modularizing the heating hardware, each module can be independently calibrated, maintained, and replaced, simplifying system integration and allowing for flexible system design based on specific product requirements. For example, a microwave module designed for high-frequency field exposure with mode stirrers and advanced shielding can be installed exclusively in one sub-chamber, while the next module includes MW heating with reduced power.

First, this solution permits each heating mode to be spatially and electrically isolated, ensuring optimal energy application and minimizing the risk of cross-mode interference. Second, the physical separation supports parallelization, allowing one product to enter one heating mode zone while another is completing the heating mode of another module, thereby increasing process efficiency. Third, maintenance and system upgrades are simplified, as each module can be serviced or replaced independently.

In a preferred embodiment, the different heating modules are arranged in line, wherein the transport arrangement comprises a conveyor or other transport mechanism configured to convey the slurry sequentially through all of the different heating modules, either continuously or in discrete batches, and wherein the heating modules are configured to permit material flow in one direction through multiple chambers or allow entry and exit through a common access point.

This configuration describes a linear processing layout in which each heating module—such as a direct current heating module, a radio frequency module, and a microwave module—is physically positioned along a continuous processing path. The slurry, contained within a mold or carrier, is transported from one module to the next by means of a mechanical transport system. The transport arrangement may include a belt conveyor, chain drive, shuttle system, or guided rail platform. The transport may operate in a continuous mode, where the molds are moved at a controlled speed without stopping, or in a batch-wise mode, where the product is indexed between stations with defined dwell times in each heating zone.

The heating modules themselves are spatially separated to permit field-specific containment and tuning, and also closing the individual modules when in batch mode to ensure radiation containment. They are aligned such that the material can move through them in sequence along a single axis or processing lane. This one-directional flow layout simplifies system design, allows compact equipment installation, and facilitates process automation.

In an alternative embodiment, the modules may be accessed via a common entry and exit point, allowing the material to return through the same door and then to be transported along the line to the next module, which again has an “in-and-out” scheme through the same exit point or door. This simplifies the layout of the individual modules, wherein the complexity is absorbed through the transporting between the modules. In such an arrangement, the modules are preferably arranged side by side along the line, such that the entry and exit point of all adjacent modules is along the line.

Compared to prior art systems in which different heating modes are applied in isolated or stand-alone chambers requiring manual transfer, the in-line multi-mode configuration with conveyor-based transport ensures faster cycle times, reduced handling complexity, and better synchronization of heating stages. It also supports integration with upstream and downstream equipment such as foam generators, demolding stations, or trimming and packaging units. The result is a streamlined production system that enhances throughput, reproducibility, and energy efficiency while maintaining precise control over each stage of thermal processing.

In a preferred embodiment, the control unit is configured to activate different ones of the heating modes within respective modules based on monitored material-state parameters monitored at locations corresponding to the slurry's position as the slurry progresses through the modules, in particular along the conveyor path.

In a preferred embodiment the chamber comprises a closed cavity or a tunnel cavity, and wherein a mold for receiving the slurry
(i) forms at least part of the cavity boundary,
(ii) is a separate mold insertable into and removable from the cavity, and/or
(iii) is conveyable through the tunnel cavity between different heating zones corresponding to the at least two heating modes.

In a preferred embodiment, the at least two heating modes having differing characteristics include at least one of
a) two heating modes with different energy levels for the same EM heating type, and
b) two heating modes with a different EM heating type, respectively.

In this embodiment the at least two heating modes having differing characteristics include at least one of two possible configurations. In configuration (a), the two heating modes involve the same type of electromagnetic heating but are operated at different energy levels. In configuration (b), the two heating modes are based on different electromagnetic heating types, each with its own physical mode of energy interaction.

In configuration (a), using two heating modes with different energy levels for the same electromagnetic heating type allows for finer control of the thermal profile during different phases of material processing. For example, microwave heating at the same frequency (such as 915 MHz) may be applied first at a lower power level for gentle drying and later at a higher power level for more aggressive moisture removal or structure fixing. Similarly, radio frequency heating at 27.12 MHz may be used initially with low field strength to avoid rapid vaporization and then intensified in a later stage to complete bulk moisture removal. The technical advantage of this approach is that it allows continuous use of the same energy delivery hardware while dynamically adjusting the intensity to match the evolving moisture content and thermal behavior of the material. This minimizes thermal shocks, reduces the risk of fiber degradation, and allows more uniform drying throughout the product.

In configuration (b), the two heating modes employ different electromagnetic heating types, such as conductive heating followed by radio frequency heating, or radio frequency heating followed by microwave heating. Each type of electromagnetic energy interacts differently with the material depending on its conductivity, dielectric properties, and moisture content. For instance, the conductive heating relies on ionic conductivity and is suitable for low-temperature preheating when water content is high. The radio frequency heating provides deep, uniform volumetric heating due to its longer wavelength, and is effective for removing bulk moisture if there are already substantial air spaces in between within the porous structure. The microwave heating, with its shorter wavelength and high-frequency energy, enables rapid surface or mid-layer drying in the final stage. The use of different heating types allows each mode to target a specific physical behavior of the fiber slurry at a specific point in its transformation process.

The technical advantage of combining different energy types lies in the ability to match the heating mechanism to the changing properties of the material throughout the drying cycle. This approach overcomes limitations of systems that rely on a single heating mode, which may be poorly matched to certain moisture levels or geometries, and which often lead to uneven drying, local overheating, or prolonged cycle times. By integrating different types of electromagnetic heating, the system achieves improved energy coupling, reduced internal moisture gradients, and greater process flexibility.

In a preferred embodiment, the heating system comprises at least three heating modes, two heating modes with different energy levels for the same EM heating type, and the third heating mode having a different EM heating type, respectively.

In a preferred embodiment, the control unit is configured for transitioning between the at least two heating modes such at least one heating mode having a higher heating power precedes a last heating mode before obtaining the formed three-dimensional biodegradable natural fiber matrix.

This feature introduces a deliberate and functionally advantageous energy staging sequence, wherein the drying process begins or proceeds through an intermediate phase with relatively high-intensity heating, and then concludes with a lower-intensity final phase that conditions and stabilizes the material before it solidifies into its final form.

As drying progresses, the fiber matrix begins to solidify, and the proportion of bound water increases. At this point, high heating power may be counterproductive, as it can result in surface overheating, uneven shrinkage, fiber degradation, or the development of internal stress gradients. Transitioning to a lower-power heating mode in the final phase allows for gentle drying and structural stabilization without damaging the partially consolidated network. This might involve reducing microwave power, switching to pulsed energy with a reduced duty cycle, or changing to a lower-intensity heating mode such as radio frequency with fine-tuned field strength.

The control unit is configured to manage this transition based on either time schedules, sensor thresholds, or predefined process recipes. The ability to automatically reduce power intensity as the drying process reaches its final stage ensures a smooth thermal gradient and consistent product quality. The final heating phase may also be used to modulate surface texture, density gradient, or mechanical stiffness through controlled moisture diffusion and slow energy input.

In an embodiment, the control unit is configured for transitioning between the heating modes such that the heating mode having the higher heating power is also preceded by another heating mode with lower heating power.

This feature introduces a sequential power escalation strategy in which thermal energy is applied progressively, beginning with a relatively low-intensity heating mode and followed by a higher-power heating stage. This progression is managed by the control unit, which determines the appropriate time or condition under which the system transitions to the more intense heating mode. The heating power progression can preferably be expressed as a bell-shaped power curve over time.

In the context of electromagnetic drying and forming of three-dimensional biodegradable fiber network products, this feature reflects a fundamental process control principle: initial gentle heating is used to prepare the material for more aggressive drying without inducing premature evaporation, fiber disruption, or structural deformation. At the early stage of the drying process, the aqueous fiber slurry contains a high proportion of water and may be mechanically fragile. Applying high-intensity heating immediately, such as full-power microwave or RF energy, can lead to rapid vaporization, uneven pressure gradients, and uncontrolled foam collapse. By introducing a lower-power heating mode first-such as low-voltage DC heating, low-power RF, or reduced-intensity microwave—the material is gradually warmed, viscosity decreases, and some free water is removed in a controlled manner. This stabilizes the foam structure and prepares it to tolerate more aggressive energy input.

Once the material has passed this critical transition phase, the control unit escalates to a higher power heating mode to complete bulk water removal or initiate final product shaping. The transition may be triggered based on elapsed time, temperature thresholds, moisture content reduction, changes in electrical conductivity, or dielectric property profiles, just to give some examples. In a preferred embodiment, the control system may include predefined transition logic that escalates power when both temperature and moisture fall within a defined intermediate range, indicating readiness for the intensified drying phase.

Further developments and embodiments include the use of multiple incremental power steps across a series of heating modes. For example, a three-stage process may begin with low-power conductive heating to initiate preheating, followed by mid-power MW heating for volumetric moisture extraction, and concluding with high-power RF heating for rapid surface drying and structural fixing, before lowering the power again. Additionally or alternatively, power can be modulated within a single heating type. In a preferred variant, a microwave system may operate in a ramping profile, beginning at 20 percent power and gradually increasing to 100 percent as the material's moisture content decreases and its ability to absorb energy without structural damage improves.

Another embodiment includes dynamic feedback loops, where the system continuously adjusts the transition points based on real-time sensor feedback. For instance, fiber swelling, foam height, or vapor release rate could be used to modulate when and how the system escalates to the higher-power phase. Transitions may also be smoothed through overlapping modes, where the lower-power mode is gradually tapered off while the higher-power mode is ramped up, ensuring thermal continuity and preventing sudden gradients that could damage the product.

The technical advantage of this staged power escalation strategy is improved product integrity, reduced energy waste, and enhanced adaptability across varying product geometries, fiber formulations, and moisture profiles. It avoids premature or excessive drying at the surface, reduces the likelihood of fiber scorching or collapse, and enables the formation of stable, reproducible three-dimensional biodegradable structures with minimal post-processing.

In an embodiment, the heating unit comprises a microwave, MW, heating subsystem and a radio frequency, RF, dielectric heating subsystem, wherein at least one of the electromagnetic energy modes is provided by the MW heating subsystem and at least another of the electromagnetic energy modes is provided by the RF dielectric heating subsystem.

Microwave (MW) heating generally refers to dielectric heating processes using electromagnetic energy in the frequency range of 300 MHz to 300 GHz, preferably operating at 915 MHz or 2.45 GHZ, both of which are internationally allocated ISM (industrial, scientific, medical) frequencies. Also further ISM allocated frequencies such as 433 MHz are of course contemplated.

In microwave heating, dipolar molecules, such as water, attempt to align with the rapidly oscillating electric field. This molecular rotation, caused by dipole reorientation lag, results in internal friction and heat generation directly within the bulk of the material.

MW treating is suitable to warm up the wet mass quickly through EM propagation. 2.45 GHz is preferred for smaller powers (e.g. <50 kW, single generator up to 6 kW) and smaller shapes (depth of propagation inside wet material), whereas 915 MHz is preferred for higher powers (for instance, single generators 100 kW and even 300 kW) and larger materials in view of the deeper penetration resulting from the longer wavelength.

The technical effect of microwave heating is the ability to produce volumetric and instantaneous heating, particularly effective for high-moisture systems. Since energy is absorbed preferably by water molecules, microwave drying is highly energy efficient, with minimal loss to surrounding material or chamber structures. Furthermore, microwave power can be modulated in real time, allowing precise control over the drying process, making the technology suitable for moisture-sensitive or shape-critical applications.

However, microwave heating exhibits certain limitations. Due to the relatively short penetration depth of microwave energy, typically limited to a few centimeters to decimeters, drying of large or dense objects may result in thermal gradients or incomplete heating. Additionally, inhomogeneous moisture distribution can lead to localized overheating (“hot spots”), which may compromise product uniformity. For these reasons, microwave heating often requires rotational stirring, mode stirring, or frequency sweeping to ensure spatial uniformity. Moreover, the implementation of microwave systems necessitates extensive shielding and leakage protection, in compliance with regulatory requirements, due to the potential hazard of high-frequency electromagnetic exposure.

Radio frequency heating refers to dielectric heating performed at lower frequencies, typically within the range of 1 MHz to 300 MHz, preferred at standard industrial frequencies such as 13.56 MHz, 27.12 MHz, or 40.68 MHz RF heating systems are commonly implemented using a capacitor-like configuration, wherein the material to be heated is placed between two conductive electrodes, and the alternating electric field induces dipole reorientation and ionic displacement currents within the medium.

RF heating differs from microwave heating in that the wavelengths involved are substantially longer, resulting in greater field penetration and a more uniform field distribution, particularly in thicker and larger volumes. The technical advantage of RF heating lies in its deep penetration and consistent volumetric heating, which is relatively insensitive to product geometry or localized variations in moisture content. This makes RF heating particularly suitable for bulk drying applications, where large amounts of moisture must be removed from the interior of the material without surface over-drying or case hardening.

Despite its advantages, RF heating is typically slower than microwave drying due to lower field strengths and reduced specific absorption rates. Additionally, RF systems require precise electrode design, with optimal spacing and impedance matching, to maintain effective energy transfer. Changes in the geometry, permittivity, or conductivity of the product during the drying process may affect system stability, requiring active power tuning or feedback control.

Given their differing penetration depths, energy absorption profiles, and field behaviors, the inventors of the present invention have recognized to use RF and microwave heating systems as complementary technologies for the generation of a three-dimensional biodegradable fiber network product. RF heating is well-suited for later moisture removal, where uniform heating throughout the volume is required. In contrast, microwave heating is ideal for rapid warm up of wet mass in the early stages of the process, enabling moisture equalization and structural locking without significant energy loss or overheating or risk of hot spots and burns.

Consequently, a combination of both RF and microwave heating, optionally preceded by preheating as discussed in preferred embodiments below, offers a multistage thermal processing strategy that can be tailored to the specific drying kinetics and structural requirements of biodegradable fiber network products.

In a preferred embodiment, the apparatus comprises a microwave heating subsystem configured for the quick warm-up and initial drying of the biodegradable fiber network product. This stage is performed after optional preheating, e.g. using resistive heating and/or before radio-frequency (RF) dielectric heating.

In a preferred embodiment, the MW heating subsystem and the RF dielectric heating subsystem are arranged in different sub-chambers of the chamber. For instance, they may be arranged in different heating modules as described above.

In a preferred embodiment the microwave heating subsystem comprises a microwave generator, preferably a solid-state generator and/or a magnetron, for generating microwave energy, and a waveguide configured to deliver the generated microwave energy to the chamber, preferably at least two orthogonally arranged waveguides or a matrix of waveguide inlets distributed across multiple positions of the chamber in particular to ensure homogeneous energy distribution.

The technical effect of multi-directional wave injection is the enhanced uniformity of the electromagnetic field within the cavity, which minimizes drying gradients and thermal inconsistencies. This results in a more isotropic mechanical behavior in the final product.

The microwave generator preferably comprises the solid-stage generator to allow dynamic sweeping the operating frequency within a predefined band, preferably 2.40-2.50 GHz or 902-928 MHz or 433.05 MHz to 434.79 MHz.

Such a solid-state frequency-agile generator allows dynamic sweeping of the operating frequency within a predefined band (e.g., 2.40-2.50 GHz or 902-928 MHz), thereby altering the field distribution over time. The technical effect of this arrangement is the reduction of hot spots and local overheating, improving product homogeneity. Solid-state generators further offer the advantage of fine power modulation and instant frequency control.

The microwave cavity is preferably formed by an electromagnetically reflective enclosure, preferably constructed from stainless steel with fully welded seams. The technical effect of this configuration is to contain the microwave energy effectively and reflect it within the cavity to maximize energy absorption by the product.

The microwave cavity may correspond to the chamber or it may correspond to part of the chamber.

In a preferred embodiment, to prevent standing wave formation and promote uniform field distribution, the cavity is equipped with a mode stirrer, such as a rotating metallic reflector, paddle wheel, or fan assembly. The stirrer is located adjacent to the waveguide inlet. The technical effect is to dynamically randomize the internal field distribution, leading to a more uniform energy absorption across the product.

Alternatively or additionally, the slurry, optionally within a dielectric mold, is mounted on a rotating turntable composed of microwave-transparent materials (e.g., quartz, alumina, PTFE), which rotates slowly during operation. The rotation leads to a time-averaged uniform exposure, improving drying consistency and reducing edge effects.

In a preferred embodiment, microwave exposure is conducted in pulsed mode, with bursts of energy (e.g., 200 ms ON/800 ms OFF) regulated by a duty cycle. The technical effect of pulsing is to enable thermal equalization between pulses, reducing the likelihood of thermal runaway or fiber degradation. A further alternative is to use amplitude or frequency modulation, where the power or frequency of the microwave signal is continuously varied during exposure to improve field dynamics.

The entire cavity or chamber is preferably enclosed within a shielded housing compliant with electromagnetic safety regulations. Shielding features can include double RF choke gaskets, labyrinth door seals, welded flanges, and optional leakage detectors at access ports. Safety interlocks are implemented to disable microwave emission when the chamber is open or improperly sealed. The technical effect is the containment of electromagnetic radiation and compliance with IEC 60335, EN 55011, or equivalent regulations.

In a preferred embodiment, the radio frequency dielectric heating subsystem includes a pair of opposing electrodes, the slurry being received between the pair of opposing electrodes.

The electrodes are preferably composed of electrically conductive, corrosion-resistant materials, such as stainless steel, aluminum, or copper. In one embodiment, the electrodes are flat parallel plates aligned vertically or horizontally with respect to the mold. The technical effect of the parallel plate arrangement is to generate a uniform electric field across the mold volume, promoting even energy distribution and thus uniform heating.

The spacing between the electrodes is preferably adjustable in the range of 5 mm to 300 mm, depending on the mold thickness and desired electric field strength. Adjustable spacing permits tuning of the field intensity and impedance matching, which in turn improves heating efficiency and avoids dielectric breakdown.

In a preferred embodiment, the radio frequency dielectric heating subsystem includes a radio frequency, RF, power generator, electrically coupled to the pair of opposing electrodes.

In a preferred embodiment, the radio frequency dielectric heating subsystem includes a matching network including variable capacitors and/or impedance tuning circuits for connecting the electrodes with the RF power generator. The purpose of the matching network is to minimize reflected power and ensure maximum energy transfer into the load (i.e., the fiber foam). The technical effect is a stable and energy-efficient heating process with minimal power losses and reduced equipment stress.

In a preferred embodiment, the radio frequency dielectric heating subsystem includes a field modulation mechanism including pulsed RF delivery or rotating electrode fields. This embodiment aims at preventing uneven heating due to non-uniform moisture distribution.

Pulsed RF delivery involves alternating periods of active heating and passive equilibration (e.g., 100 ms ON/400 ms OFF). The technical effect is improved thermal equalization and reduction of hot spots, particularly in asymmetric geometries.

In a preferred embodiment, the radio frequency dielectric heating subsystem includes an RF switching matrix enabling spatially shifted field orientation.

The apparatus comprises a radio frequency (RF) dielectric heating subsystem configured for the volumetric heating and partial drying of the biodegradable fiber network product.

The RF heating stage is preferably performed after optional preheating via resistive or conductive heating such as direct current (DC) resistive heating, as will be described below, and prior to microwave exposure.

The technical effect of RF dielectric heating is the penetrative and uniform volumetric generation of heat within the water-laden fiber matrix, enabling rapid removal of internal moisture while preserving structural homogeneity and material integrity. This mode of heating is particularly effective during the intermediate drying phase, where bulk water removal is required but precise density tuning is not yet critical.

The RF subsystem in this embodiment comprises at least one RF power generator, preferably operating at standardized industrial frequencies such as 13.56 MHz, 27.12 MHz, or 40.68 MHz, depending on the dimensions and dielectric properties of the product. The preferred frequency for most mold sizes is 27.12 MHz, which offers a practical balance between penetration depth and energy controllability.

In a preferred embodiment, the RF dielectric heating subsystem is configured to apply a power density between 1 kW and 5 kW per kilogram of aqueous fiber solution.

In a preferred embodiment, the electrodes are shaped in a conformal or curved geometry, adapted to match the surface contour of a mold surrounding the slurry or a final product and/or wherein the electrodes are perforated and form at least part of the mold for receiving the slurry.

This embodiment describes a multifunctional integration of the radio frequency heating subsystem or the conductive heating electrodes with the mold structure itself, enabling the electrodes to serve both as energy delivery components and as the physical shaping form for the slurry.

In the context of dielectric heating using radio frequency energy, the electrode geometry directly influences the distribution of the electric field within the material. Traditional RF systems often use flat, parallel-plate electrodes that create a uniform field across a regular volume. However, this configuration is less effective when processing complex or three-dimensional geometries, where uniform field exposure is difficult to achieve without sacrificing coupling efficiency or increasing the risk of local under- or over-drying.

When the electrodes themselves are used to define at least part of the mold geometry, this eliminates the need for a separate dielectric mold body in that region. This integration simplifies the system architecture, reduces the number of parts, and enhances thermal and electrical contact. The electrodes may be perforated with controlled pore sizes to allow the release of water vapor during heating, supporting controlled drying without inducing pressure build-up or foam deformation. These perforations also contribute to field uniformity and can be used to guide airflow or support vacuum-assisted shaping processes.

Further developments and embodiments include the use of modular electrode mold inserts that can be rapidly interchanged depending on the product geometry. These inserts may be manufactured from conductive materials such as stainless steel or carbon-loaded polymers and may be surface-treated or coated to optimize their interaction with the slurry and prevent adhesion or degradation. In another embodiment, the conformal electrodes may be segmented or include embedded sensors for real-time monitoring of temperature, local field strength, or material impedance.

The electrodes may be operated in pairs, with an upper and lower conformal section closing around the foam-filled cavity. Alternatively, a single curved electrode may act as a primary energy source with a planar ground plate to complete the circuit. In another variant, the electrodes may be flexibly mounted or hinged to adapt to different mold sizes or to open and close during the loading and unloading phases.

The technical advantage of integrating the mold function into the RF electrodes lies in improved spatial energy distribution, enhanced process compactness, and increased field efficiency. It enables the heating system to be precisely adapted to the product geometry, reduces part-to-part variability, and supports the formation of detailed or irregular product shapes. Compared to systems that apply RF heating from external flat electrodes while using separate molds, the conformal electrode approach ensures better alignment of thermal and geometric boundaries, leading to improved drying uniformity and lower energy losses. It also opens up the possibility of continuous or semi-continuous molding and heating workflows, where the mold-electrode assembly acts as both form and function in a single integrated unit.

In a preferred embodiment, the heating modes comprise a conductive heating subsystem, wherein the control unit is preferably configured to apply conductive DC and/or AC heating to the slurry prior to providing another heating mode to the slurry.

The embodiment specifies that the heating modes comprise a conductive heating subsystem. This means that, as part of the broader electromagnetic heating system, a subsystem is included which provides thermal energy to the fiber slurry by means of conductive heating, specifically through the use of direct current (DC) or alternating current (AC) electrical flow through the electrically conductive aqueous phase of the material.

In the context of processing natural fiber-based aqueous slurries, conductive heating provides a distinct and advantageous mechanism for early-stage preheating. When the slurry is freshly foamed or deposited into a mold, it exhibits high moisture content and significant ionic conductivity due to dissolved salts or stabilizers. By applying a low-voltage electrical potential across two electrodes in contact with the slurry, current flows through the ionic medium and generates resistive heating in situ. This heating is inherently volumetric and uniform, as it is governed by the distribution of conductivity in the bulk fluid, and is particularly effective when initiating the drying process under low thermal stress conditions.

Further developments and embodiments of this feature include the use of multiple forms of conductive heating. In one embodiment, the conductive heating subsystem may be implemented using DC voltage in the range of for instance 5 to 30 volts, applied via metal electrodes that are either flat, curved, or conformal to the mold shape. The system may include current limiters and safety circuits to prevent overheating or short-circuiting when material conductivity is high.

In another embodiment, the system may use pulsed DC heating, in which current is applied in controlled bursts with defined duty cycles. This enables more precise control of average power input and allows thermal relaxation between pulses, which helps prevent localized overheating and prolongs electrode life. Pulsed operation also reduces the risk of electrolysis and material degradation at the electrode surfaces.

In a further preferred embodiment, the conductive subsystem may use low-frequency AC heating. By alternating the current direction at a defined frequency (e.g. 50-1000 Hz), the system avoids net ion migration and electrode corrosion, which can occur during prolonged DC exposure. AC heating also improves long-term stability and may provide smoother temperature gradients in the slurry.

The conductive heating subsystem may be implemented using electrodes that are integrated into the mold itself, optionally shared with a radio frequency dielectric heating subsystem. In this case, the same pair of electrodes can be used initially for low-voltage DC or AC conductive heating, and subsequently for high-frequency RF energy delivery, controlled by the system through switching electronics or a multi-function power driver. The integration of conductive and RF functions into the same hardware simplifies mechanical layout and reduces system cost while maintaining precise control over the thermal conditioning phases.

Additional embodiments may include the incorporation of sensors, such as current sensors, voltage monitors, and embedded thermocouples, to allow the control unit to monitor the heating rate and material response. This feedback enables the system to determine when to terminate conductive heating and transition to the next heating mode, such as a different heating type including RF or microwave drying.

The technical advantage of including a conductive heating subsystem as part of the overall multi-mode heating system is that it allows for gentle and energy-efficient preheating, ideal for initiating drying in high-moisture slurries while preserving foam structure and fiber distribution. It reduces total cycle time, improves energy coupling in subsequent heating stages, and supports automated, sensor-driven process control.

In a preferred embodiment, the conductive heating subsystem comprises at least two electrodes, the electrodes preferably being integrated as electrodes of at least one further heating mode, in particular the heating modes implemented by the RF dielectric heating subsystem.

In a preferred embodiment, the apparatus comprises a control unit or system configured to execute the thermal treatment of biodegradable fiber network products using a multi-stage electromagnetic heating process.

In a preferred embodiment, the sub-chambers comprise a first sub-chamber and a second sub-chamber, and the two heating modes comprise a first heat mode and a second heating mode. The first heating mode is microwave heating, and the second heating mode is radio-frequency heating. The first sub-chamber is associated with the first heating mode for initial heating, and the second sub-chamber is associated with the second heating mode for final heating. The transport arrangement is configured to convey an intermediate product from the first sub-chamber to the second sub-chamber.

The control unit orchestrates transitions between the different heating modes using multiple, configurable strategies:
1. Time-Based Sequencing: Each stage is executed for a fixed duration defined in the process recipe. This is suitable for standardized products with predictable thermal profiles and is simple and robust to implement.
2. Sensor-Triggered Transitioning: Transition between stages occurs when one or more sensor thresholds are crossed. For example: —Transition from conductive heating to MW when T>45 °C or σ decreases by more than 50%.—Transition from MW to RF when M<20% or vapor flow drops below 10 ml/min. The technical advantage is the creation of self-adaptive drying profiles that respond to real-time material behavior.
3. Recipe-Based Control: A preconfigured set of target curves for T (t), M (t), and (t), along with specific mode durations, field strengths, and transition criteria, are stored in a digital process recipe memory. Recipes include emergency shutoffs, power ramps, and system interlocks.
   The technical effect is reproducibility across production batches and compliance with quality and traceability requirements.
4. Hybrid Time+Sensor Strategy: A combination approach where time-based defaults are overridden when sensor criteria are satisfied earlier. This ensures safety and robustness even if sensor values become unreliable or are temporarily unavailable.

All strategies can be managed through a human-machine interface (HMI), which allows the operator to select control mode, input parameters, and monitor real-time process data. Recipe libraries, user authentication levels, and audit trail functionality may be provided to support regulated or traceable environments.

In a further aspect, a method of producing a three-dimensional biodegradable natural fiber matrix is suggested, comprising the following steps:
(a) preparing a natural fiber slurry, preferably cellulose fiber based slurry;
(b) filling the slurry in a chamber;
(c) applying electromagnetic energy to the natural fiber slurry using a heating unit capable of operating in at least a first electromagnetic heating mode and a second electromagnetic heating mode, wherein the two electromagnetic heating modes have differing heating characteristics;
(d) controlling the heating of the natural fiber slurry to remove fluid in the slurry, so as to form the three-dimensional biodegradable natural fiber matrix.

The controlling can comprises transitioning between the first and second electromagnetic heating modes in accordance with a monitored heating mode condition.

The method according to the present disclosure allows to achieve all advantages as described with regard to the present apparatus. Moreover, all preferred embodiments of the apparatus can likewise be combined with the described method.

In a preferred embodiment, the chamber comprises at least a first sub-chamber and a second sub-chamber, the first sub-chamber being associated with the first electromagnetic heating mode, and the second sub-chamber being associated with the second electromagnetic heating mode. The method can further comprise: filling the natural fiber slurry in the first sub-chamber. The transition between the first electromagnetic heating mode and the second electromagnetic heating mode can comprise conveying the slurry from the first sub-chamber to the second sub-chamber.

In a preferred embodiment, the first electromagnetic heating mode is microwave heating and the second electromagnetic heating mode is radio frequency heating.

In a further preferred embodiment, the microwave heating is carried out in the first sub-chamber, and the radio frequency heating is carried out in the second sub-chamber. The method can further comprise conveying an intermediate product from the first sub-chamber to the second sub-chamber.

This embodiment allows the batch-like production in which plural modules, each associated with one heating mode, respectively, are arranged and the slurry is transported between the respective modules.

Further examples and preferred embodiments will be described with reference to and be apparent from the following description of the enclosed figures.

### DESCRIPTION OF FIGURES

FIG. 1 schematically illustrates a first embodiment of a heating apparatus 10 comprising a single integrated heating chamber;

FIG. 2 shows an alternative embodiment in which the heating apparatus 10 comprises two physically separate heating chambers;

FIG. 3 illustrates a flowchart chowing a control logic process for transitioning between heating stages;

FIG. 4 is a schematic diagram of an apparatus according to an exemplary embodiment;

FIG. 5 is an exploded-view of the apparatus according to another exemplary embodiment;

FIG. 6 shows steps of producing the 3D biodegradable fiber matrix according to an embodiment;

FIG. 7 shows an exemplary apparatus at an industrial scale;

FIG. 8 shows another exemplary apparatus at an industrial scale.

FIG. 9 shows an example of heat mode modulation over plural stages;

FIG. 10 shows a further example of heat mode modulation over plural stages;

FIG. 11 shows a further example of heat mode modulation over plural stages;

FIG. 12 provides a demonstration of the sample, showing both sagging and warping;

FIG. 13 shows a collection (“pile”) of various samples;

FIGS. 14a and 14b illustrate a sample that exhibits excellent dimensional stability;

FIGS. 15a and 15b illustrate a different sample from two sides;

FIG. 16 compares cross-sections at three dryness stages for single-step MW vs. stepwise MW→RF;

FIG. 17 schematically illustrates the power vs. time profiles for multi stage EM drying.

### DETAILED DESCRIPTION

Details of the present invention including exemplary embodiment will be described in the following along with the figures.

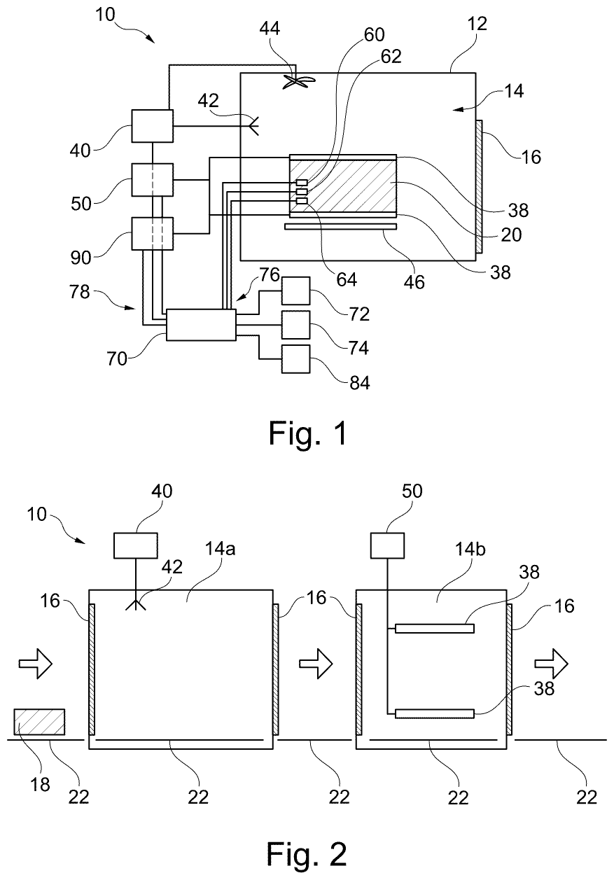

FIG. 1 schematically illustrates a first embodiment of a heating apparatus 10 comprising a single integrated heating chamber 14. The housing 12 encloses all functional elements necessary for performing heating operations with different heating modes sequentially within a unified cavity. A door allows access to the heating chamber 14.

A dielectric mold 18 is positioned within the chamber, filled with the fiber foam material 20. Alternatively, the foam material 20, also referred to as slurry, is provided direct within the heating chamber 14.

The mold is located between a pair of electrode plates 38, which are configured to selectively operate in a DC mode using a DC power supply 90, or in an RF mode via the RF generator 50 and an optional matching network 48. Above the chamber is a microwave generator 40 connected to a waveguide 42, which directs energy into the cavity for microwave heating. A mode stirrer 44 and optionally a turntable 46 ensure field uniformity. It should be noted that this arrangement is merely an example and other arrangements are contemplated. The different heating modes can include one more or all of resistive heating with different characteristics, RF heating with different characteristics and MW heating with different characteristics.

Embedded within or adjacent to the mold are various sensors, including a temperature sensor 60, moisture sensor 62, and conductivity sensor 64, all connected to a central control unit 70, which receives input via sensor input channels 76 and actuates subsystems through actuator output channels 78. The entire chamber is enclosed within electro-magnetic shielding. The central control unit 70 activates one out of a plurality of heating modes using one or more type of heating, including conductive heating, RF heating and/or MW heating. The central control unit activates either RF generator 50, MW generator 40 or DC power supply 90 in this example based on sensor values or on elapsed time in accordance with timing controller 84.

All decision points are evaluated by the control unit 70, which accesses timing controller 84 and reference conditions stored in a recipe memory 74. Manual override and parameter adjustment may be performed through a human-machine interface (HMI) 72.

FIG. 2 shows an alternative embodiment in which the heating apparatus 10 comprises two physically separate heating chambers. A first chamber 14a is dedicated to MW heating modes and includes microwave generator 40 and waveguide 42. A second chamber 14b is dedicated to RF heating operations, including electrode plates 38, and RF generator 50. The slurry enclosed in an optional dielectric mold 18 is transferred from the first to the second chamber using a transport system 22, such as a motorized shuttle or conveyor.

Both chambers are equipped with sensors and optionally all other features as illustrated in FIG. 1, and are monitored and coordinated by the central control unit 70, which are not illustrated in FIG. 2 for the sake of simplicity. Each chamber includes independent EM shielding. Further a retractable wall 16 (not shown) may be arranged between the sub-chambers.

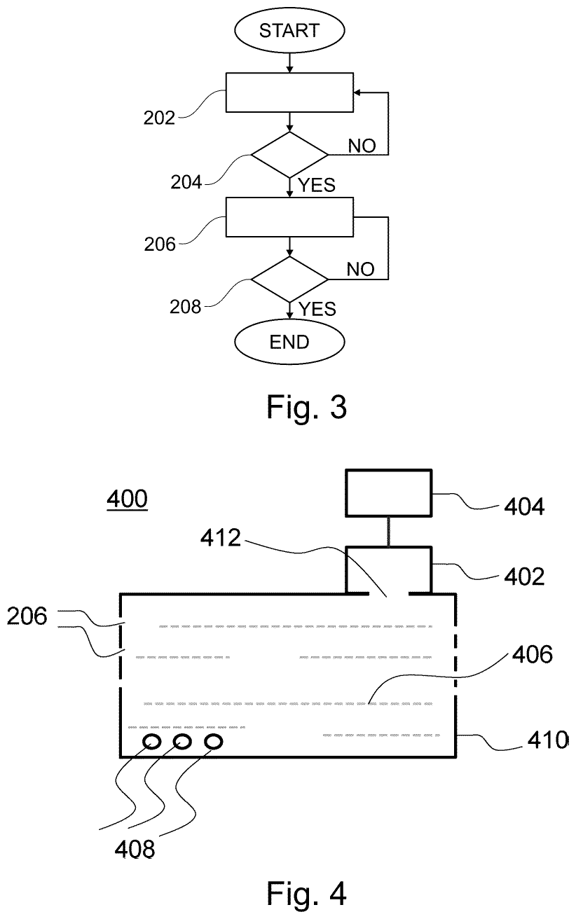

FIG. 3 illustrates a flowchart showing a control logic process for transitioning between heating stages.

The logic begins in step 202 with the initiation of heating in a first heating mode, for instance a resistive or conductive heating stage, during which temperature (T), conductivity (o), and/or moisture (M) are monitored by sensors 60, 62, and 64 respectively. Alternatively, the elapsed time is monitored such that it is not necessary to provide any sensors within the cavity.

In step 204, based on threshold values or elapsed time (e.g. T>T₁, σ<σ₁, or t>t₁), the system transitions to a second heating mode in step 206, for instance to microwave heating, activated by the microwave generator 40.

For instance moisture and temperature are continually monitored in step 208, and upon reaching M<M₁ or t>t₂, for instance, the process ends. In other examples, another heating mode in addition to the two illustrated heating modes is activated, for instance the system progresses to RF heating, initiated by the RF generator 50.

Between the respective heating modes, the process can include transporting the slurry between various sub-chambers, implementing one out of the respective heating modes each.

FIG. 4 is a schematic diagram of an apparatus according to another exemplary embodiment of the present invention, which may also be combined with the example of FIG. 1 or FIG. 2. It is noted that the location of the pores and their size, as well as other elements, are not to scale and are for exemplary purpose only. The apparatus 400 comprises a chamber 410. The chamber 410 has a different shape than the chamber in FIG. 1 or FIG. 2. A plurality of pores 206 are provided on both side walls of the chamber 410. Fiber based slurry 406, corresponding to the foam material 20, are received in the chamber 410.

In a preferred embodiment, the fiber based slurry or foam material 20 is cellulose fiber based slurry. Cellulose is a carbohydrate, or polysaccharide, consisting of a linear chain of several hundred to many thousands of β (1→4) linked D-glucose units. It is an essential structural component of the primary cell wall of green plants, many forms of algae, and the oomycetes. In the present invention, the source of the cellulose used is not limited. It can stem from wood, cotton, hemp, or even recycled paper. They are biodegradable and thus offer an environment-friendly solution to oil spill cleaning up.

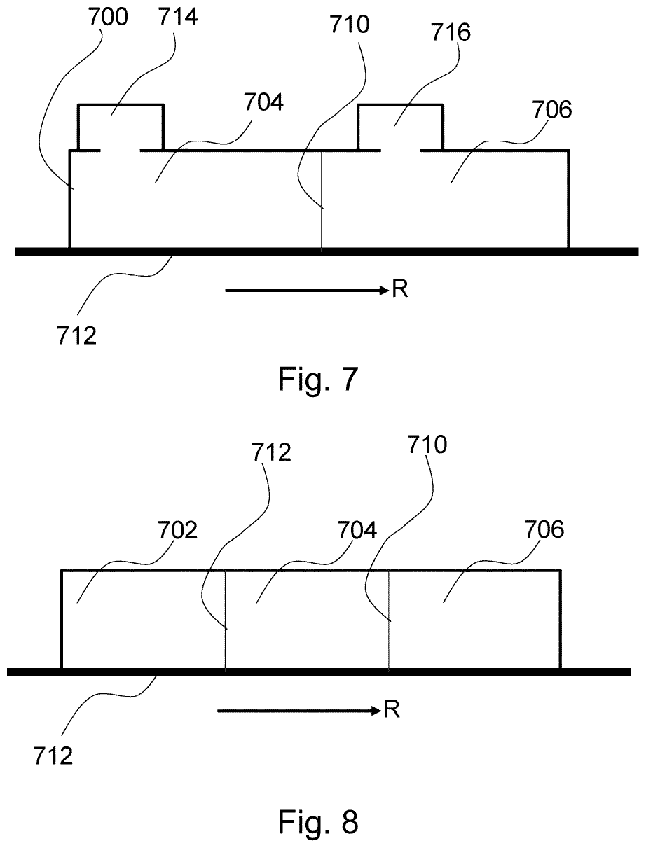

In a preferred embodiment, the slurry is foamed to bring air into the slurry, so as to improve the internal structure of the final product. Any suitable method of foaming known in the prior art can be used to foam the fiber slurry. The foaming process will be introduced along with FIG. 7.

Above the chamber 410 there is provided a heating unit 402. It goes without saying that the heating unit may also be provided at a side, or below the chamber, according to specific application needs. The heating unit 402 is configured to heat the slurry 406 inside the chamber 410. For this purpose, an open channel or open space 412 is provided at the side of the chamber 410 adjacent to the heating unit 402, so as to provide a channel to guide electromagnetic waves generated by the heating unit 402.

According to the present invention, the heating unit is able to apply microwave heating and radio frequency heating to the slurry. This is preferably achieved by providing a microwave generator and a radio frequency generator in the heating unit. The microwave generated may range from 300 MHz to 300 GHz. Particularly, the microwave can operate at a frequency of 2.45 GHZ, which conforms the 2.4 GHz ISM band. The radio frequency generated may range from 1 MHz to 300 MHz, for example, 380 kHz, 2 MHz, 13.56 MHz, 27.12 MHz or 40.68 MHz.

Alternatively, the heating unit may comprise a multi-mode electromagnetic wave generator being able to generate both microwaves and radio frequency waves. This may be achieved through variable capacitors, varactors, or digital frequency synthesizers. Different waveguides or antennas may be used for dedicated microwave and radio frequencies, and the heating unit may be switched between the microwave mode and radio frequency mode by the control unit. Alternatively, commercial multi-function wave generator directly available in the market can also be chosen.

In a preferred embodiment, the heating unit 402 may also be able to apply conductive heating. Conductive heating can be achieved by transferring heat through direct contact between a hot surface and the material to be heated. For instance, a heat source, which could be an electric heater, can be made to direct contact with the slurry to heat the latter. Alternatively, if the chamber 410 is made of metal, it can be directly used as a heat source when being applied with an electric field.

Within the chamber 410, one or more sensors 408 may be provided to measure state parameters in the chamber, such as temperature, moisture, and/or pressure. These sensors may be different types of sensors, such as moisture sensors, temperature sensors, and/or pressure sensors. It may also be multi-sensor that is able to measure multiple parameters by a single sensor. The sensors 408 are connected to a control unit 404 either wired or wirelessly.

Connected to both with the sensors 408 and the heating unit 402 is the control unit 404. The control unit 404 is configured to control the heating unit 402 based on the state parameters measured by the sensors 408. The controlling process will be described in FIG. 7. Depending on specific requirements of the application, the control unit 404 can be realized using various technologies. For instance, it can be implemented by using a microcontroller (μC), a personal computer (PC), a tablet, or an industrial computer, which has a high processing capabilities for sophisticated tasks. The control unit can interface with the sensors 408 and the heating unit 402 through data acquisition systems or communication protocols like USB, Ethernet, or wireless protocols. For remote monitoring and control, the control unit 404 may include communication modules such as Wi-Fi, Bluetooth, or cellular modules. The control unit 404 can also be provided with a user interface, such as a touchscreen or a web-based application, which allows operators to monitor system status, configure parameters, or manually control the heating process.

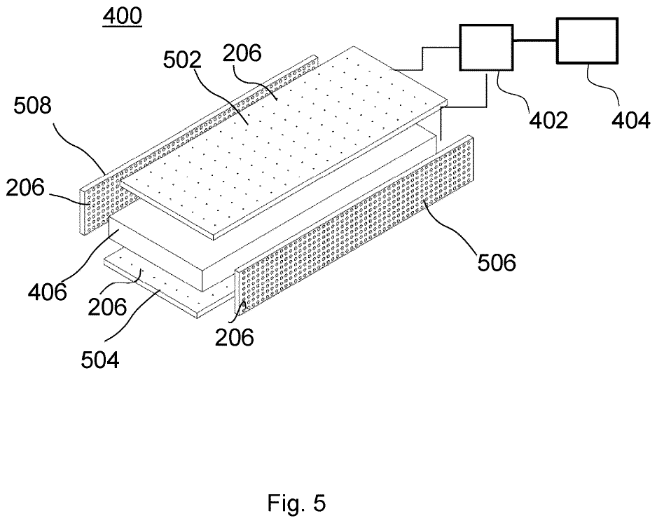

FIG. 5 is shows an exploded-view of the apparatus 400 according to another embodiment. In FIG. 5, elements that are same to the elements in FIG. 4 are denoted with same reference numerals. In this embodiment, the chamber comprises four plates 502, 504, 506 and 508, whereby the two plates 502 and 504 may also serve as electrodes of the heating unit 402. As such, extra electrodes for the heating unit can be saved. The metal plates 502 and 504 are also provided with pores 206. The function of the other elements in this embodiment is same as that of in FIG. 4, and is thus omitted here.

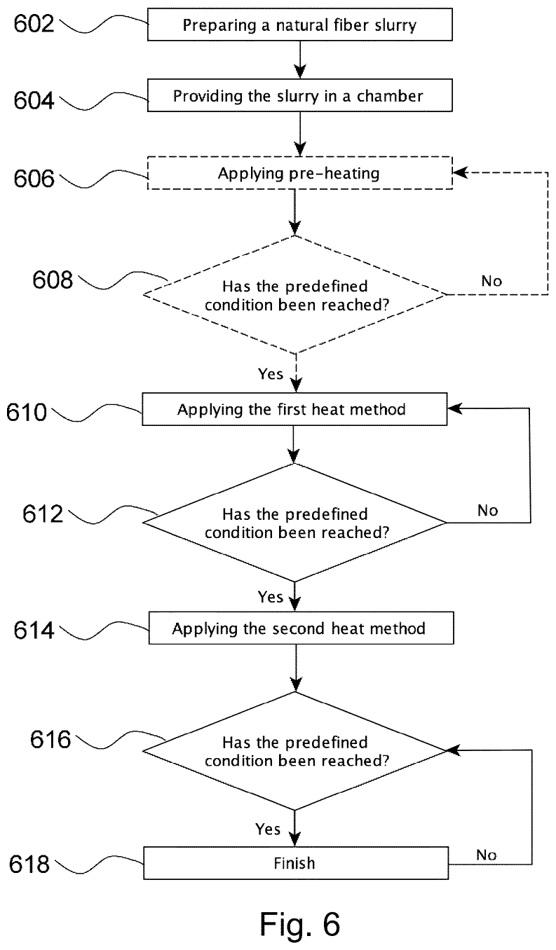

FIG. 6 shows steps of producing the 3D biodegradable natural fiber matrix according to an embodiment. The method starts with the step 602 in which a natural fiber slurry is prepared. The slurry is prepared by method known in the art. For example, wet defibrated cellulose is sterilized in a boiling solution for a certain period of minutes. Following sterilization, the fibers are dried to a moisture content then dry defibrated in a high-speed mill. Next, one or more binder solutions are prepared. In a preferred embodiment, the slurry is foamed to improve the final quality of the product. This may for example be achieved by introducing gas (bubble) into the slurry. Furthermore, foam agent and foam stabilizer can be applied to maintain the desired properties of the foam until the fibers stiffen under heating, so as to form a supporting structure (skeleton) for the final product. Blowing agent and surfactant can also be applied to increase the amount of gas filling the bubbles and control the susceptibility of the foam. Biodegradable foam stabilizers in form of polysaccharides may be used. In particular, chitosan and/or agar are preferable biodegradable foam stabilizers. The main goal of foam stabilizers is to extend the life of wet foam, and to support the mechanical stability of the final product. In a preferred embodiment, coco glucoside may be used as the foaming agent to meeting various environmental standards. Also, biodegradable blowing agents may be introduced to aid the foam formation. The preferred blowing agents are sodium carbonate and sodium bicarbonate, which have minimal impact on the environment.

At step 604, the prepared slurry is provided into a chamber, such as those shown in FIGS. 2 to 5. Depending on the production scale, the slurry may be filled into the chamber manually, or automatically.

After filling and sealing the chamber, the heating unit starts to heat the slurry. Before applying the first heating method at step 610, the slurry may be pre-heated, which is shown as step 606. The steps 606 and 608 are shown in dashed lines as they are optional. The pre-heating process at step involves using the heating unit to pre-heat the cold and very wet slurry initially to a predefined temperature. In a preferred embodiment, the pre-heating may involve conductive heating, such as resistance heating. Such heating method warms up the slurry quickly because at this stage the slurry has the highest water content, which means that the slurry at this stage has the best thermal conductivity.

The sensors provided in the chamber is configured to provide state parameters to the control unit. At step 608, if it is decided that the predefined condition has been reached (the “Yes” branch), such as if the temperature reaches 100 °C, the control unit switches to the first heating method-step 610. The aim of the first heating method is to remove a great part of water contained in the slurry, such as 70% or more, or 80% or more, or 90% or more. In a preferred embodiment, the first heating method is microwave heating. For example, a wave generator may generate microwaves with power of 1.8 kW at 2.4 GHz in the chamber for 8 minutes. If a pre-heating was adopted, the time of the microwave heating may be reduced to four or five minutes. This could potentially save a lot of energy at an industrial production scale. The microwave heating can not only remove the moisture in the slurry based on heating the water to its vaporization temperature, it can also push water out through the pores due to the pressure gradient formed in the chamber. Thus, water is both vaporized and expelled from the slurry.

At step 612, if it is decided that the predefined condition has been reached (the “Yes” branch), such as if the temperature reaches 230 °C, and/or if the pressure started to drop, and/or if the moisture content is reduced to 20%, the control unit switches to the second heating method-step 614.

In a preferred embodiment, the second heating method is radio frequency heating. Although the first heating method, such as microwave heating, can remove water in the slurry at a short period of time, the penetration depth is shallow compared to radio frequency heating. Furthermore, microwave heating tends to result in hot spots, which could burn the fiber. The second heating method is thus used to compensate the first heating method.

The preferred radio frequency heating works at a lower frequency range and emits longer wavelength. Thus, it can heat the slurry more evenly and penetrates deeper in the slurry, to “catch” the cold spots left by the microwave heating.

In a preferred embodiment, the radio frequency heating aims to remove substantially all water in the slurry, such as 99%, or 99.9%.

At step 616, if it is decided that the predefined condition has been reached (the “Yes” branch), such as if the moisture has been reduced to 1%, or 0.1%, the heating process finishes. However, it goes without saying that the step 618 does not have to be the final step of the production. For example, products coming out from the step 616 can be subjected to post-drying, or cutting, according to specific application needs.

FIG. 7 shows an exemplary apparatus at an industrial scale. The chamber 700 shown in FIG. 7 comprises a first sub-chambers 704 and a second sub-chamber 706. The sub-chambers 704 and are provided on a conveyor belt 712, which runs towards a direction shown as R. The first sub-chamber 704, which is equipped with a first heating unit 714, is configured to receive the first heating method. The second sub-chamber 706, which is equipped with a second heating unit 716, is configured to receive the second heating method. The first sub-chambers 704 and the second sub-chamber 706 are separated by a retractable wall 710. At its default states, the retractable wall 710 may be placed or retracted. When production starts, the retractable wall 710 is placed between the first sub-chambers 704 and the second sub-chamber 706 to separate the two chambers. After filling the first sub-chamber 704 with slurry, the first heating method is applied in the first sub-chamber 704. The control unit monitors state parameters in the first sub-chamber 704. When a predefined condition has been reached, the control unit retracts the wall 710 and activates the conveyer belt, so that the semi-finished product in the first sub-chambers 704 can be transferred to the second sub-chamber 706. A distance sensor may be implemented to monitor whether the semi-finished product has been fully moved into the second sub-chamber 706. Alternatively, the conveyer belt may be configured to run a predefined distance at each activation. After the first sub-chamber 704 is emptied, it can be filled again with slurry for heating. Meanwhile, after the semi-finished product completely settles in the second sub-chamber 706, the retractable wall 710 is placed and the conveyer belt 712 is stopped. The second heating unit 716 then applies the second heating method to the semi-finished product, to completely dry the product. The production flow repeats and the two heating methods can be applied simultaneously, thus increase production rate.

In other examples the sub-chambers 704 and 706 are arranged side by side such that the slurry enters and exists the respective sub-chambers through the same opening.

FIG. 8 shows another exemplary apparatus at an industrial scale. The apparatus in FIG. 8 differs from the apparatus in FIG. 7 in that it has a third sub-chamber 702 and a second retractable wall 712. The third sub-chamber 702, which is equipped with a third heating unit (not shown), is configured to receive the pre-heating. The pre-heating method is same as the pre-heating method described in FIG. 6, the detailed description is thus omitted.

At their default states, the retractable walls 710 and 712 may be placed or retracted. When production starts, the retractable wall 712 is placed between the third sub-chambers 702 and the first sub-chamber 704 to separate the two chambers. After filling the third sub-chamber 702 with slurry, pre-heating is applied in the third sub-chamber 702. The control unit monitors state parameters in the third sub-chamber 702. When a predefined condition has been reached, the control unit retracts the wall 712 and activates the conveyer belt, so that the semi-finished product in the third sub-chambers can be transferred to the first sub-chamber 704. A distance sensor may be implemented to monitor whether the semi-finished product has been fully moved into the first sub-chamber 704. Alternatively, the conveyer belt may be configured to run a predefined distance at each activation. After the third sub-chamber 702 is emptied, it can be filled again with slurry for heating. Meanwhile, after the semi-finished product completely settles in the first sub-chamber 704, the retractable wall is placed and the conveyer belt 712 is stopped. The first heating unit then applies the first heating method to the semi-finished product, to completely dry the product. After the first heating finished, the semi-finished product is transferred to the second sub-chamber 706. The process is the same as that described in FIG. 7 and is thus omitted. The production flow repeats, and the three heating methods can be applied simultaneously, thus significantly increasing the production rate.

The embodiments described above are provided by way of example only and are intended to help the skilled person to understand the present invention. It is understood that a person skilled in the art is able to make various modifications and changes. Such modifications and adaptations are intended to be within the scope of the claims as defined by the appended claims and their equivalents.

Various dielectric drying techniques have been proposed for fiber-based foams or biodegradable matrices in order to accelerate water removal and reduce energy consumption. Notably, microwave (MW) drying alone was employed but was prone to non-uniform heating (hot spots) and local shrinkage in thicker materials since MW energy can create steep moisture gradients once superficial water has evaporated. Further, other attempts to use radio-frequency (RF) heating alone provided deeper penetration but proved slower in the early phases of high-moisture foams.

These approaches encountered significant difficulties, including: Partial overdrying and burned spots in certain areas; Uncontrolled product puffing or shrinkage; Formation of internal fiber lumps (“flocks”) due to uneven moisture removal; and excessive energy consumption due to suboptimal drying techniques.

The technical challenges arise primarily from the dramatic changes in moisture levels during processing, which significantly alter the material's interaction with electromagnetic fields. Specifically:
1. Wet biomass initially requires high energy levels for effective drying.
2. As drying progresses, the changing dielectric properties of the material alter field penetration depths.
3. Optimal generator-to-applicator matching conditions vary throughout the process as moisture content changes.
4. Standard MW applications risk creating harmful pressure buildup, destroying the foam and hot spots.
5. Uniform RF energy distribution is too weak for efficient initial drying of wet mass.

To overcome these drawbacks, the present invention introduces stagewise or hybrid EM drying, that is, multiple heating modes including different microwave frequencies, modulated power levels, and/or integrated radio-frequency treatment with time-based sequencing or in multiple chambers optimized for specific process stages.

The process proceeds in preferred embodiments as follows:
1. High-power microwave early stage, which rapidly removes bulk liquid when the material's moisture content (MC) is high, and the risk of local overheating is comparatively low.
2. Reduced-power or different-frequency microwave phase, which moderates the internal vapor pressure once the MC drops (e.g., below ~30%), thereby limiting hot spots and preventing abrupt fiber twisting or lumps.
3. Final radio-frequency heating, when local dryness has partially advanced, an RF field is introduced to even out residual moisture pockets volumetrically, preventing partial overdry zones and reducing product shrinkage.

The present invention represents a significant advancement over prior art. This advancement follows a logical progression:
1. First, moving beyond the exclusive application of a single EM technique/frequency.
2. Next, implementing multiple MW techniques in one process with intelligent control systems.
3. Finally, integrating RF treatment as a post-MW step.

Although changing power levels may seem straightforward, determining optimal power levels for different EM techniques at various stages of moisture content is non-obvious and represents a key innovation.

Pulsing in this process has particular technical significance beyond mere energy efficiency:
The actual process is always a combination of EM heating and impingement drying that ensures the evacuation of moisture (steam) from the material.
Depending on the amount of steam created within the material, there are practical limits to the power delivery.
Excessive continuous power can create too high local pressure buildup inside the material, destroying the foam structure and substantially increasing the risk of hot spots.
Pulsed operation creates critical pauses that allow steam evacuation while preventing destructive pressure accumulation.

### Example 1

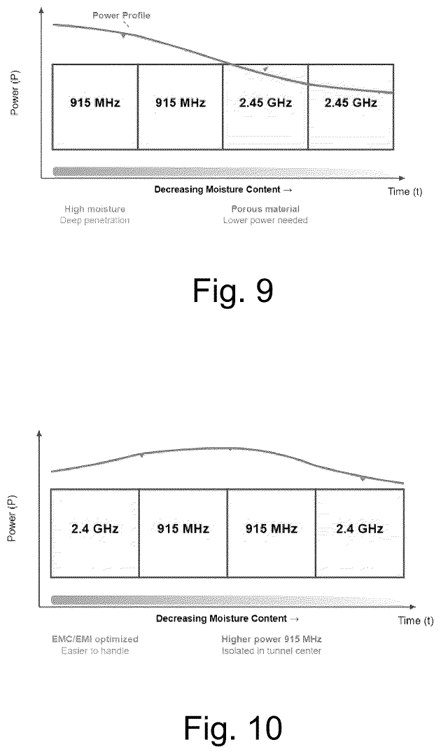

In one preferred implementation, microwave power is modulated in distinct stages as illustrated in FIG. 9.
Stage 1 applies a lower frequency (for instance, about 915 MHz) or moderate power to ensure deep initial penetration when the product is highly wet, avoiding too sudden a vapor surge.
Stage 2 switches to a higher frequency (for instance, about 2.45 GHZ) and higher power after partial dewatering, accelerating moisture release in the mid-layers.
Stage 3 optionally reverts to lower power or pulses the MW to avoid local dryness extremes, simultaneously measuring moisture or temperature to detect incipient scorching.

After these MW phases, if the foam is still above a targeted MC threshold (e.g., 5-15%), radio frequency is briefly introduced to unify final dryness.

This multi-frequency design is grounded in recognizing that each frequency exhibits a different penetration depth in wet foam. Early in the process, deeper penetration fosters uniform initial heating. Then, focusing on near-surface or intermediate layers with a slightly higher frequency helps drive out water before any region hits the critical dryness threshold that leads to flocking.

### Example 2

In another preferred implementation, an EMC/EMI-optimized MW processing configuration with microwave power being modulated in distinct stages as illustrated in FIG. 10.

This configuration demonstrates a strategic arrangement of microwave frequencies that optimizes system simplicity and electromagnetic compatibility/interference (EMC/EMI) considerations. The processing tunnel employs 2.4 GHz modules at both the entrance and exit points, with 915 MHz modules positioned in the central section. The 2.4 GHz modules are deliberately placed at the tunnel boundaries where they interface with the external environment. This arrangement provides superior EMC/EMI protection as 2.4 GHz radiation is more easily contained and shielded at these critical junctures, reducing potential electromagnetic leakage and simplifying regulatory compliance. The higher-power 915 MHz modules, which present greater EMC/EMI challenges, are strategically positioned deeper within the tunnel's central section, benefiting from the natural shielding provided by the tunnel structure and adjacent modules. This arrangement is particularly advantageous in manufacturing environments where EMC/EMI compliance is critical, and system simplicity reduces maintenance complexity and operational costs.

### Example 3

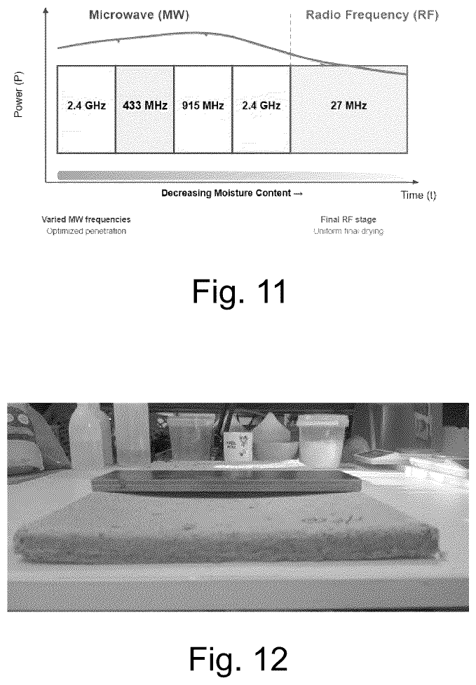

In another preferred implementation, a Hybrid MW+RF processing configuration is suggested as illustrated in FIG. 11.

This configuration represents an advanced approach to biodegradable fiber matrix drying by combining multiple microwave frequencies with a final radio frequency stage. It demonstrates the progression from rapid initial MW drying to precision final RF treatment for optimal moisture uniformity.

The sequence combines strategic microwave frequencies (2.4 GHZ→433 MHz→915 MHz→2.4 GHZ) followed by RF (27 MHz) treatment. This arrangement allows 433 MHz to be positioned near MHz, simplifying internal interference management between sections. The RF stage provides superior uniformity in final drying, ensuring consistent product quality without overdried areas or moisture pockets.

In practical applications, this system can be calibrated based on specific product requirements. Processing may be achieved using only the MW stages for lower-density materials, while higher-density products benefit significantly from the final RF treatment. This approach is particularly effective when product specifications demand precise moisture control and exceptional uniformity while offering flexibility for different material densities and recipe requirements.

### Exemplary Control Logic and Sensor Feedback

The control unit monitors at least one or more of:
Dielectric properties of the foam-fiber network
Steam flow rate and/or internal product pressure
Local temperature or moisture measured by embedded or contactless sensors

When an internal sensor reading indicates that average moisture has fallen below a setpoint (for example, 80%), the controller transitions from the initial microwave frequency or power stage to the subsequent stage, e.g., from moderate MW to higher-power MW or from MW to final RF.

Typical example thresholds might be:
Temperature surpassing 80 °C
Evaporative flux dropping below 10 ml/min
Moisture in local fiber domain reaching 20%

### Mitigation of Dimensional Stability Issues

Non-uniform drying often leads to dimensional instability in thick foam-fiber products, manifesting primarily as sagging or warping. As used herein:
Sagging refers to localized droop or indentation in a surface, typically resulting in a concavity on the top or bottom face. This occurs when one region of the product loses moisture too quickly relative to adjacent regions, causing uneven shrinkage in that localized area.
Warping is a more global deformation, in which the entire product bends or twists out of its intended shape. This typically arises when moisture gradients are present from one side or edge of the product to the opposite side, thus pulling the product's geometry away from the original plane.

FIG. 12 provides a demonstration of the sample, showing both sagging and warping.

With single-frequency MW, a wide spread in moisture is observed across interior vs. surface layers, often exceeding a 10-15% difference, which leads to dimensional stability issues.

By contrast, the staged method shows a uniform dryness profile, with variations typically under 2-3%.

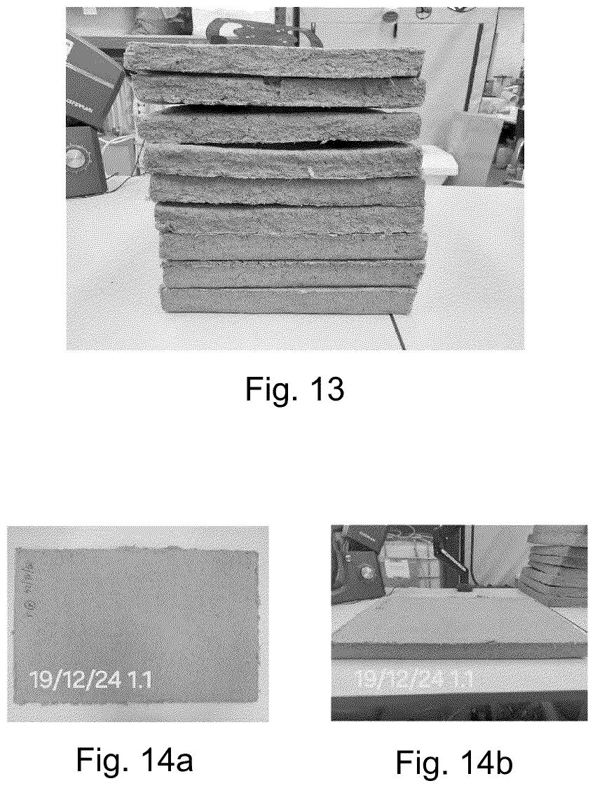

FIG. 13 shows a collection (“pile”) of various samples, each demonstrating how purely altering drying strategies (e.g., different microwave profiles, partial radio-frequency finishing, or distinct ramp schedules) can dramatically affect final geometry. Some samples exhibit nearly perfect shape fidelity, while others display significant concavities or global curling.

FIG. 14a and FIG. 14b illustrate a sample that exhibits excellent dimensional stability after a staged electromagnetic (EM) drying process. By controlling power levels or switching frequencies at appropriate intervals, moisture distribution remains relatively uniform (less than ~2-3% variation), and the resultant product shows minimal surface droop or global curvature. The images present the same sample from two sides, emphasizing the absence of obvious sagging or warping.

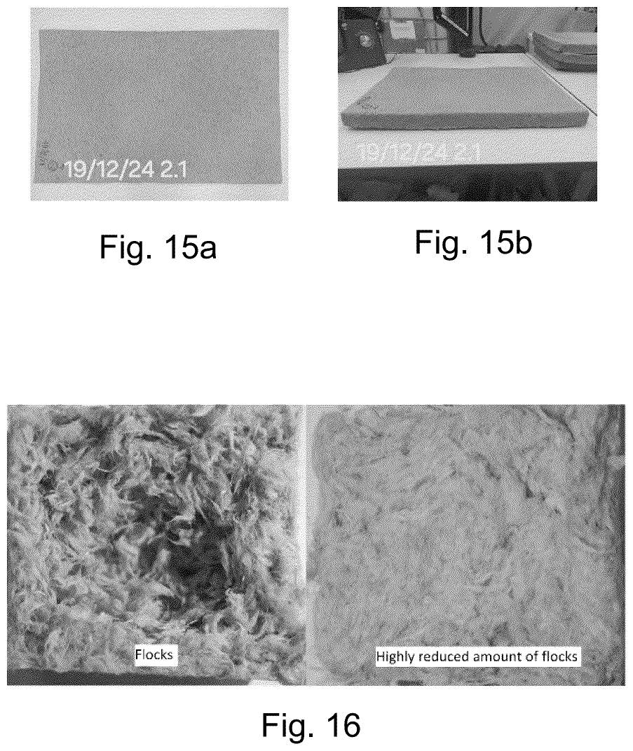

By contrast, FIG. 15a and FIG. 15b show a different sample (again, viewed from two sides) that underwent single-frequency, single-power microwave drying. The interior vs. surface moisture difference, which can exceed 10-15%, has led to uneven shrinkage and visible dimensional changes, particularly on the top surface. Warping is discernible in the edges, and a subtle sag is evident near the center.

### Mitigation of “Flock” Formation and Hot Spots

An additional discovery is that an extended single-frequency microwave in the late drying phase tends to amplify fiber “curling,” producing stiff flocks. By alternating or reducing microwave power in the final 10-20% dryness window or switching to an RF finishing pass, these flock-inducing gradients are minimized. Specifically, an extended dwell in moderate-power MW or short bursts of higher-power MW, followed by a final uniform RF pass, prevents local temperature spikes. The result is a softer, more uniform fiber matrix with minimal lumps.

FIG. 16 compares cross-sections at three dryness stages for single-step MW vs. stepwise MW→RF. The single-step samples show partial bridging and lumps after dryness surpasses 80%, whereas the staged samples remain open and pliable.

Efficiency Gains with Multi-Stage MW-RF Processing

A trial was conducted to demonstrate the efficiency improvements achieved through the multi-stage electromagnetic drying approach compared to conventional single-frequency drying methods.

Biodegradable cellulose foam with an initial moisture content (MC) of approximately 1.50-1.65 achieved through the MW stage was processed through three different drying configurations:
1. Configuration A: Single-frequency MW (2.45 GHZ).
2. Configuration B: Single-frequency RF (27.12 MHz).
3. Configuration C: Multi-stage processing (MW→RF).

The experimental results revealed significant efficiency advantages for the multi-stage approach:

| | Config A: | Config B: | Config C: | |
|---|---|---|---|---|
| Parameter | Single MW | Single RF | MW→RF | Improvement |
| Processing time (min) | 8.5 | 15.0 | 7.0 | 53% vs. Config |
| | | | | B |
| Energy consumption | 1.9 | 1.8 | 1.4 | 22% reduction |
| (kWh/kg water) | | | | |
| Moisture gradient (upper | 0.68 | 0.70 | 0.35 | 50% |
| vs. lower) | | | | improvement |
| Post-processing required | Yes | Yes | No | 100% |
| | | | | elimination |

The multi-stage approach demonstrated superior performance by optimizing the power profile across different moisture content ranges.

The rationale behind the results:
1. Initial MW Stage (2.45 GHZ):
   Rapid removal of bulk moisture when the material has high water content
   Effective power transfer to moisture-laden fibers
   Prevention of overheating through precise power control
2. Subsequent RF Stage (27.12 MHz):
More uniform field distribution in partially dried material
   Deep penetration for consistent moisture removal throughout volume
   Prevention of “flock” formation and dimensional instability

The transition point between the MW and RF stages was determined by monitoring moisture content, with the optimal transition occurring at approximately 1.15 MC. This staged approach eliminated the need for secondary processing, yielding a final product with:
MC uniformity variation of less than 0.04 between samples
Dimensional stability without warping or sagging
Uniform fiber distribution without problematic flocks

### Multi-Stage EM Drying for Enhanced Dimensional Stability

This example demonstrates how the multi-stage electromagnetic (EM) heating approach significantly improves the dimensional stability of biodegradable fiber matrix products compared to conventional single-frequency approaches.

The cellulose-based foam was formed into uniform samples with a foam density of approximately kg/m³. Five different EM power profiles were tested, each delivering the same total energy (90 Wh) but with different power distributions:
1. Constant: 0.9 kW for 6 minutes
2. Profile 1: Five-stage approach (0.4→0.8→1.2→0.8→0.4 kW) for 7.5 minutes
3. Profile 2: Five-stage approach (0.6→1.2→1.8→1.2→0.6 kW) for 5 minutes
4. Profile 3: Five-stage approach with shorter low-power stages (0.6→1.2→1.8→1.2→0.6 KW) for 3.75 minutes
5. Profile 4: Five-stage approach with higher peak power (0.6→1.2→2.5→1.2→0.6 kW) for 3 minutes

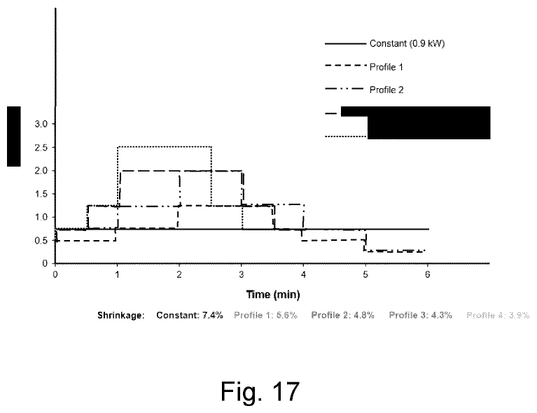

FIG. 17 schematically illustrates the power vs. time profiles for multi stage EM drying.

All samples were prepared identically and processed in identical molds. Product thickness was measured as the primary indicator of dimensional stability.

The measurement results clearly demonstrated the superior dimensional stability of the optimized multi-stage approach:

| EM Profile | Max Power (kW) | Total Time (min) | Thickness (mm) | Shrinkage (%) |
|---|---|---|---|---|
| Constant | 0.9 | 6.0 | 21.40 ± 0.14 | 7.4 |
| Profile 1 | 1.2 | 7.5 | 21.81 ± 0.77 | 5.6 |
| Profile 2 | 1.8 | 5.0 | 22.00 ± 1.25 | 4.8 |
| Profile 3 | 1.8 | 3.75 | 22.13 ± 1.36 | 4.3 |
| Profile 4 | 2.5 | 3.0 | 22.21 ± 1.38 | 3.9 |

The multi-stage Profile 4, which incorporated the highest peak power (2.5 kW) for a shorter duration, showed the least shrinkage (3.9%) compared to the constant low-power approach (7.4% shrinkage) while maintaining the same total energy input in much shorter processing time for continuous manufacturing scaling.

The rationale behind the results:

### 1. Impact of Power Distribution.

Lower constant power (0.9 kW) resulted in significantly more shrinkage (7.4%) compared to higher constant power (0% shrinkage at 1.85 kW). This demonstrates that power distribution throughout the drying process directly affects dimensional stability.

### 2. Importance of High-Power Stages.

Even when utilized for a short duration, higher power stages (Profile 4 with 2.5 kW peak) reduced shrinkage by creating sufficient internal steam pressure to maintain the product's dimensional integrity.

### 3. Duration Optimization.

Minimizing the duration of lower power stages (Profile 3 vs. Profile 2) improved dimensional stability by 0.5%, confirming that shorter exposure to lower powers reduces shrinkage.

### 4. Effective Power Sequencing

The multi-stage approach with optimized power sequencing (Profile 4) reduced shrinkage by 47% compared to the constant low-power approach (Constant 2) despite using the same total energy input.

The principal mechanism behind these improvements involves controlled steam generation. Higher power stages rapidly generate internal steam pressure that counteracts the natural tendency of the fiber matrix to shrink as moisture is removed. By optimizing the sequence of different power levels, the multi-stage approach maintains sufficient internal pressure during critical drying phases while avoiding the risks associated with continuous high-power application. The results conclusively demonstrate that the specific power sequencing in the multi-stage approach provides technical advantages that would not be obvious from conventional single-frequency drying techniques.

### Enablement & Best-Mode Gaps

Thorough analysis of the inventors resulted in concrete, workable ranges for key parameters to enable a person skilled in the art to practice the invention without undue experimentation. This includes:
Power densities: Effective drying utilizes staged power densities. The initial MW stage typically employs 0.5 to 5 kW per kg of initial water for rapid bulk water removal [Timofeev et al., 2016]. Subsequent RF stages often use lower densities, such as in the range of 0.2 to 1 kW per kg of material, for uniform final drying and preventing overheating. This contrasts with potentially higher initial MW power densities and aligns with the goal of achieving uniform heating, particularly in thicker materials where RF excels [Dubey et al., 2016]. The control unit adjusts power density based on the operational mode and sensor feedback.
Frequencies: Frequency selection impacts energy delivery. Typical ISM bands are employed: 2.45 GHZ or 915 MHz for MW, offering rapid heating or deeper penetration respectively, and 13.56 MHz or 27.12 MHz for RF, providing highly uniform heating in thicker or lower-moisture materials. A sequential application, for example 2.45 GHZ MW followed by 27.12 MHz RF, leverages these distinct advantages.
Material properties: Control efficacy relies on the slurry's changing dielectric properties (ε′ and ε″). At operating frequencies, these properties strongly depend on moisture and temperature. For example, ε′ can decrease from 20-40 (wet slurry) down to 3-5 (dry material), while ε″ (loss factor) significantly increases with moisture [consistent with general trends for cellulosic materials, e.g., Zhu et al., 2021]. This variation allows sensors (capacitive, resonant shift) to infer moisture content, enabling the control unit to switch modes or adjust power based on detected dielectric changes meeting predefined thresholds.
Process conditions: Volumetric EM heating rapidly increases internal slurry temperature, potentially exceeding 100 °C. This generates steam and internal pressure within the chamber/mold, aiding moisture expulsion [Timofeev et al., 2022]. The control unit manages this by adjusting power density or employing pulsed operation (duty cycle control) based on sensor feedback (e.g., temperature sensors) to prevent material scorching and ensure controlled drying.
Sensor thresholds: The control unit executes mode transitions based on monitored parameters reaching set points. Illustrative thresholds include: switching from MW to RF mode when inferred average moisture content drops below 15% to 30% (wet basis); or transitioning when the rate of temperature increase measured by sensors significantly slows [Timofeev et al., 2022]. These thresholds are configurable, often within pre-defined process recipes.

### Evidence of Technical Effect

Improved product quality: The sequential application of different electromagnetic modes, particularly transitioning from MW to RF, results in superior final product quality, especially for three-dimensional articles of significant thickness. Comparative observations indicate reduced shrinkage, warping, and instances of cracking or surface scorching compared to products dried solely using microwaves or conventional methods. This is attributed to the more uniform energy distribution in the later drying stages provided by RF heating, which minimizes internal stresses and avoids localized overheating, a known issue in extended MW drying of thicker materials [Timofeev et al., 2022, observed charring in thick 50 mm foam samples with MW only]. Photographic evidence comparing products from the inventive method versus MW-only drying can illustrate these quality improvements.
Enhanced energy efficiency: The hybrid MW-RF approach offers improved energy efficiency compared to relying on either mode alone for the entire drying process. The initial MW stage rapidly and efficiently removes the bulk free water due to water's high microwave absorptivity, achieving high drying rates [Timofeev et al., 2016, reported high MW drying rates]. Subsequently switching to the RF stage for removing the remaining, often bound, moisture leverages RF's efficient heating of lower moisture content material [Dubey et al., 2016, compared RF and MW heating efficiency] and avoids the energy wastage associated with MW-induced hotspots in drier regions. Data comparing the total energy consumption (e.g., kWh per kg of water removed) for the inventive hybrid method versus single-mode MW or RF processes to reach the same target final moisture content demonstrates this improved efficiency and/or reduced overall drying time.
Superior drying uniformity and hotspot elimination: A key advantage of the present invention is the achievement of highly uniform final moisture distribution throughout the product volume. While MW heating can be prone to creating non-uniform heating patterns and hotspots, especially as the material dries [Monga Group, 2024], the subsequent application of RF energy effectively mitigates this. RF heating inherently provides more uniform energy deposition in larger volumes and preferably heats the remaining wetter areas, facilitating moisture leveling [Dubey et al., 2016, showed more uniform RF heating in large wood sections]. This results in a product free from the localized hotspots or charred areas often observed in thick materials subjected to prolonged MW drying. Evidence for this includes moisture mapping data from sectioned samples or comparative visual inspection showing the absence of burn marks in products dried using the inventive method.

### REFERENCE LIST

Dubey, M. K., Janowiak, J. J., Mack, R., Elder, T., & Shupe, T. F. (2016). Comparative study of radio-frequency and microwave heating for phytosanitary treatment of wood. In Proceedings of the 59th International Convention of Society of Wood Science and Technology. Curitiba, Brazil.
Monga Group. (2024). Understanding Microwave and Radio Frequency Heating in an Industrial Setting. Monga Group White Paper.
Timofeev, O., Sandberg, C., Nabi, G., Bohrnsen, F., & Wälinder, M. (2016). Drying of foam-formed mats from virgin pine fibers. Drying Technology, 34(10), 1210-1218.
Timofeev, O., Prat, E., Rantanen, J., & Ketola, A. (2022). Drying of thick foam formed mats comprising chemithermomechanical pulp fibers. BioResources, 17(1), 1245-1259.
Zhu, H., Huang, Z., Fan, D., & Wang, S. (2021). Dielectric properties of edible fungi powder related to radio-frequency and microwave drying. Food Production, Processing and Nutrition, 3, 14.

1. An apparatus for producing a three-dimensional biodegradable fiber network product, comprising:
a chamber having an internal volume, the chamber being configured to receive natural fiber-based slurry;
a heating unit configured to heat the slurry received in the chamber, comprising a heating system configured to transmit electromagnetic, EM, energy to the slurry, the heating system comprising at least two heating modes with differing heating characteristics, respectively; and
a control unit configured to control the heating of the natural fiber based slurry using the heating unit to remove fluid in the slurry, so as to form the three-dimensional biodegradable natural fiber matrix,
wherein the control unit is configured to monitor a heating mode condition for transition between the at least two heating modes in accordance with the heating mode condition.

2. The apparatus of claim 1, wherein the differing heating characteristics are selected from the group comprising: heating type, frequency, power density, duty cycle, field distribution, or any combinations thereof, wherein the differing heating characteristics preferably comprise frequencies differing by at least a factor of two, more preferably by at least a factor of ten.

3. The apparatus of any one of the preceding claims, wherein the differing heating characteristics differ by at least 10% in at least one heating characteristic, the 10% being determined based on the higher of the two values.

4. The apparatus of any one of the preceding claims, further comprising:
at least one sensor, configured to monitor one or more material-state parameters of the slurry, preferably the material-state parameters are selected from the group comprising weight, moisture content, temperature, dielectric permittivity, electrical conductivity, steam pressure, vapor flow, or cumulative energy input history,
wherein the control unit is configured to transit between two of the at least two heating modes when a parameter monitored by the at least one sensor reaches a predetermined threshold or profile.

5. The apparatus of any of the preceding claims, wherein the transition between the at least two electromagnetic energy modes is based on at least one of:
(a) a monitored parameter; and
(b) a predetermined time duration.

6. The apparatus of any of the preceding claims, wherein the chamber is composed of a plurality of sub-chambers, each implementing one of the at least two heating modes, further comprising:
a transport arrangement, configured to transfer the slurry between the plurality of sub-chambers in accordance with a control by the control unit.

7. The apparatus of any of the preceding claims, wherein the heating system comprises a plurality of heating modules, each heating module being associated with one of the heating modes and, preferably, with one of the plurality of sub-chambers.

8. The apparatus of claims 6 and 7, wherein the different heating modules being arranged in line, wherein
the transport arrangement comprises a conveyor or other transport mechanism configured to convey the slurry sequentially through all of the different heating modules, either continuously or in discrete batches, and wherein
the heating modules are configured to permit material flow in one direction through multiple chambers or allow entry and exit through a common access point.

9. The apparatus of claim 6, 7 or 8, wherein the control unit is configured to activate different ones of the heating modes within respective modules based on monitored material-state parameters monitored at locations corresponding to the slurry's position as the slurry progresses through the modules, in particular along the conveyor path.

10. The apparatus of any of claims 6 to 9, wherein the chamber comprises a closed cavity or a tunnel cavity, and wherein a mold for receiving the slurry
(i) forms at least part of the cavity boundary,
(ii) is a separate mold insertable into and removable from the cavity, and/or
(iii) is conveyable through the tunnel cavity between different heating zones corresponding to the at least two heating modes.

11. The apparatus of any of the preceding claims, wherein the at least two heating modes having differing characteristics include at least one of
a) two heating modes with different energy levels for the same EM heating type, and
b) two heating modes with a different EM heating type, respectively.

12. The apparatus of any of the preceding claims, wherein the heating system comprises at least three heating modes, two heating modes with different energy levels for the same EM heating type, and the third heating mode having a different EM heating type.

13. The apparatus of any of the preceding claims, wherein
the control unit is configured for transition between the at least two heating modes such that at least one heating mode having a higher heating power precedes, directly or indirectly with intermediate other heating modes, a last heating mode before obtaining the formed three-dimensional biodegradable natural fiber matrix, wherein preferably a MW heating mode precedes an RF heating mode in the final heating sequence, wherein
the control unit is preferably further configured for transition between the heating modes such that the heating mode having a higher heating power is also preceded by another heating mode with a lower heating power.

14. The apparatus of any of the preceding claims, wherein
the heating unit comprises a microwave, MW, heating subsystem and a radio frequency, RF, dielectric heating subsystem,
wherein at least one of the electromagnetic energy modes is provided by the MW heating subsystem and at least another of the electromagnetic energy modes is provided by the RF dielectric heating subsystem,
wherein preferably the MW heating subsystem and the RF dielectric heating subsystem are arranged in different sub-chambers of the chamber.

15. The apparatus of any of the preceding claims, wherein the heating modes comprise a conductive heating subsystem, wherein the control unit is preferably configured to apply conductive DC and/or AC heating to the slurry prior to providing another heating mode to the slurry, wherein the conductive heating subsystem preferably comprises at least two electrodes, the electrodes more preferably being integrated as electrodes of at least one further heating mode, in particular the heating modes implemented by the RF dielectric heating subsystem.

16. The apparatus of any of the preceding claims, wherein the control unit is configured to control the switching between the at least two heating modes based on logic selected from:
time-based sequencing, wherein transition occurs after a predefined duration for a mode;
sensor-triggered transition, wherein transition occurs when one or more monitored material-state parameters cross predefined thresholds;
recipe-based control, wherein preconfigured target parameter curves and transition criteria determine transition; and/or
a combination or two or more of the preceding modes.

17. The apparatus of any of claims 6 to 16, wherein the sub-chambers comprise a first sub-chamber and a second sub-chamber, and the two heating modes comprise a first heat mode and a second heating mode, wherein the first heating mode is microwave heating, and the second heating mode is radio-frequency heating, wherein the first sub-chamber is associated with the first heating mode for initial heating, and the second sub-chamber is associated with the second heating mode for final heating, wherein the transport arrangement is configured to convey an intermediate product from the first sub-chamber to the second sub-chamber.

18. A method of producing a three-dimensional biodegradable natural fiber matrix, comprising the following steps:
(a) preparing a natural fiber slurry, preferably cellulose fiber based slurry;
(b) filling the natural fiber slurry in a chamber;
(c) applying electromagnetic energy to the natural fiber slurry using a heating unit capable of operating in at least a first electromagnetic heating mode and a second electromagnetic heating mode, wherein the two electromagnetic heating modes have differing heating characteristics;
(d) controlling the heating of the natural fiber slurry to remove fluid in the slurry, so as to form the three-dimensional biodegradable natural fiber matrix, wherein the controlling step comprises transitioning between the first and second electromagnetic heating modes in accordance with a monitored heating mode condition.

19. The method of claim 18, wherein the chamber comprises at least a first sub-chamber and a second sub-chamber, the first sub-chamber being associated with the first electromagnetic heating mode, and the second sub-chamber being associated with the second electromagnetic heating mode, and the method further comprises:
filling the natural fiber slurry in the first sub-chamber, wherein
the transition between the first electromagnetic heating mode and the second electromagnetic heating mode comprises conveying the slurry from the first sub-chamber to the second sub-chamber.

20. The method of claim 18 or 19, wherein the first electromagnetic heating mode is microwave heating and the second electromagnetic heating mode is radio frequency heating.

21. The method of claim 20, wherein the microwave heating is carried out in the first sub-chamber, and the radio frequency heating is carried out in the second sub-chamber, and the method further comprises conveying an intermediate product from the first sub-chamber to the second sub-chamber.
